(19) United States
(12) Patent Application Publication
(10) Pub. No.: US 2014/0297600 A1
(43) Pub. Date: Oct. 2, 2014

(54) Bayesian Sleep Fusion

(71) Applicants: Kevin Gar Wah Kan, Philadelphia, PA (US); Christopher Grey Mott, Seattle, WA (US); Daniel Joseph Mollicone, Seattle, WA (US); Michael D. Stubna, Philadelphia, PA (US)

(72) Inventors: Kevin Gar Wah Kan, Philadelphia, PA (US); Christopher Grey Mott, Seattle, WA (US); Daniel Joseph Mollicone, Seattle, WA (US); Michael D. Stubna, Philadelphia, PA (US)

(21) Appl. No.: 14/279,292

(22) Filed: May 15, 2014

Related U.S. Application Data
(60) Provisional application No. 61/793,211, filed on Mar. 15, 2013.

(51) Int. Cl. G06F 11/34

(52) U.S. Cl. CPC G06F 11/3452
USPC 707/688

(57) ABSTRACT

Systems and methods to estimate a subject's sleep status over time by applying data-fusion algorithms to sleep data sets collected from multiple sleep data sources are disclosed. Embodiments employ Bayes' Theorem to combine sleep data from actigraphy, sleep diary, direct observation, sleep schedules, work schedules, performance tests, neurobehavioral tests and/or the like. Particular embodiments assign data error characteristics to each source, determine likelihoods of correct reporting of sleep status from each source, and apply Bayesian analysis to each source-specific likelihood to determine an overall sleep status estimate. Data error characteristics may account, without limitation, for data insertion errors, data deletion errors, and sleep timing errors. Heuristics may be also used to correct common errors found within collected sleep data and/or to infer sleep status from atypical sources of sleep data. Particular embodiments may also use the combined sleep status estimate for fatigue prediction utilizing various biomathematical fatigue models.

### STATEMENT OF GOVERNMENT FUNDED RESEARCH

This invention was made with government support under Contract No. NNX10CA99C awarded by the National Aeronautics and Space Administration (“NASA”). The government may have certain rights in the invention.

### TECHNICAL FIELD

The present invention relates generally to the statistical aggregation of data from multiples sources, each with differing error characteristics and values thereof, and relates specifically to the statistical aggregation of sleep data from multiple sleep data sources with particular data-error characteristics.

### BACKGROUND

Human fatigue estimates play a vital role in scheduling certain high-stakes operations. Various mathematical models will accept as input various sleep schedules (among other things) to gauge future alertness and/or fatigue states such that work schedules may be optimized to reduce risk of fatigue-related incidents. While idealized future sleep schedules can be ascertained or specified with a high degree of certainty, often actual sleep schedules differ from the ideal to a greater or lesser extent. So that fatigue predictions may be accurate, it becomes important to keep close track of actual sleep schedules—i.e., time of sleep onset, duration of sleep, time of wake onset, and/or the like.

Several methods exist to measure when and for how long a subject sleeps, such as (without limitation) sleep journals, human and/or video observation, actigraphy, EEG, core body temperature monitoring, performance testing, and/or the like. Each sleep measurement method can have errors or uncertainty that vary with the type of measurement and other conditions. Sleep journals, for example, may be imprecise because of time rounding errors (e.g., entries rounded to the nearest 15 or 30 minute interval, etc.), and subjective perception errors. Other forms of measurement such as actigraphy may have errors due to misinterpretation of motion signals. The need for accuracy makes it not uncommon for two or more of such sleep-schedule measurement techniques to be used simultaneously in some operational settings. When sleep data is available from multiple sources, rather than just selecting the measurements from a preferred source, there could be improvements in accuracy by combined data from all sources that incorporate statistical probability. What is needed, then, is a system, a device, and/or a method whereby discrepancies in sleep data collected from multiple sleep-schedule measurement techniques may be consolidated into a unified sleep schedule that matches the actual sleep schedule based on the data collected and optionally provides uncertainty values or ranges based on the uncertainty within the data collected.

### SUMMARY

The presently disclosed invention attempts to address this need by applying statistical methods to combining sleep data collected from multiple sources. According to particular embodiments, the presently disclosed invention comprises a method, using a computer, for determining a multisource probabilistic sleep estimate for an individual, the method comprising: receiving, at a computer, a plurality of sleep data for an individual within a time interval of interest, each sleep data comprising data that indicates a sleep-wake status of the individual at one or more times; converting each sleep data to a sleep state function, each sleep state function representing a likelihood of the individual being in a particular sleep-wake state at one or more times within the time interval of interest; and determining, with the computer, a multisource probabilistic sleep estimate for the individual by applying a data fusion algorithm to the received plurality of sleep state functions, wherein the data fusion algorithm comprises a combining operation operating on each of the sleep state functions.

According to particular embodiments, the presently disclosed invention comprises a method, using a computer, for determining an estimated fatigue level for an individual based upon a multisource probabilistic sleep estimate, the method comprising: receiving, at a computer, a plurality of sleep data for an individual within a time interval of interest, each sleep data comprising data that indicates a sleep-wake status of the individual at one or more times; converting each sleep data to a sleep state function, each sleep state function representing a likelihood of the individual being in a particular sleep-wake state at one or more times within the time interval of interest; determining, with the computer, a multisource probabilistic sleep estimate for the individual by applying a data fusion algorithm to the received plurality of sleep state functions, wherein the data fusion algorithm comprises a combining operation operating on each of the sleep state functions; and determining, with the computer, an estimated fatigue level for the individual by applying a mathematical fatigue model to the determined multisource probabilistic sleep estimate, the estimated fatigue level being indicative of a neurocognitive or neurobehavioral state of the individual, the mathematical fatigue model comprising a biomathematical model capable of determining a neurocognitive or neurobehavioral state of an individual based at least in part upon sleep data as input. According to particular embodiments, the presently disclosed invention comprises a computer program product embodied in a non-transitory medium and comprising computer-readable instructions that, when executed by a suitable computer, cause the computer to perform a method for determining a multisource probabilistic sleep estimate, the method comprising: receiving, at a computer, a plurality of sleep state functions for an individual within a time interval of interest, each sleep state function representing a likelihood of the individual being in a particular sleep-wake state at one or more times within the time interval of interest; and determining, with the computer, a multisource probabilistic sleep estimate for the individual by applying a data fusion algorithm to the received plurality of sleep state functions, wherein the data fusion algorithm comprises a combining operation operating on each of the sleep state functions.

According to particular embodiments, the presently disclosed invention comprises a computer program product embodied in a non-transitory medium and comprising computer-readable instructions that, when executed by a suitable computer, cause the computer to perform a method for determining an estimated fatigue level for an individual based upon a multisource probabilistic sleep estimate, the method comprising: receiving, at a computer, a plurality of sleep data for an individual within a time interval of interest, each sleep data comprising data that indicates a sleep-wake status of the individual at one or more times; converting each sleep data to a sleep state function, each sleep state function representing a likelihood of the individual being in a particular sleep-wake state at one or more times within the time interval of interest; and determining, with the computer, a multisource probabilistic sleep estimate for the individual by applying a data fusion algorithm to the received plurality of sleep state functions, wherein the data fusion algorithm comprises a combining operation operating on each of the sleep state functions; and determining, with the computer, an estimated fatigue level for the individual by applying a mathematical fatigue model to the determined multisource probabilistic sleep estimate, the estimated fatigue level being indicative of a neurocognitive or neurobehavioral state of the individual, the mathematical fatigue model comprising a biomathematical model capable of determining a neurocognitive or neurobehavioral state of an individual based at least in part upon sleep data as input.

According to particular embodiments, the presently disclosed invention comprises a system for determining a multisource probabilistic sleep estimate for an individual, the system comprising: a plurality of sleep status indication sources, the sleep status indication sources capable of reporting the sleep-wake status of on an individual over a time period of interest; and a sleep data fusion module, the sleep data fusion module capable of determining a multisource probabilistic sleep estimate by applying a data fusion algorithm to the reported sleep-wake status of the individual as provided by the plurality of sleep status indication sources, the multisource probabilistic sleep estimate being representative of a probabilistic estimated sleep status of the individual over the time interval of interest as indicated by the plurality of sleep status indication sources.

According to particular embodiments, the presently disclosed invention comprises a system for determining an estimated fatigue level for an individual based upon a multisource probabilistic sleep estimate, the system comprising: a plurality of sleep status indication sources, the sleep status indication sources capable of reporting the sleep-wake status of on an individual over a time period of interest; a sleep data fusion module, the sleep data fusion module capable of determining a multisource probabilistic sleep estimate by applying a data fusion algorithm to the reported sleep-wake status of the individual as provided by the plurality of sleep status indication sources, the multisource probabilistic sleep estimate being representative of a probabilistic estimated sleep status of the individual over the time interval of interest as indicated by the plurality of sleep status indication sources; and a biomathematical computation module, the biomathematical computation module capable of determining an estimated fatigue level of the individual by applying a biomathematical fatigue model to at least in part the determined multisource probabilistic sleep estimate, wherein the biomathematical fatigue model comprises a biomathematical model capable of determining a fatigue state of an individual based at least in part on sleep data.

### BRIEF DESCRIPTION OF THE DRAWING

Exemplary embodiments are illustrated in referenced figures of the drawings. It is intended that the embodiments and figures disclosed herein are to be considered illustrative rather than restrictive. In drawings which illustrate non-limiting embodiments:

FIG. 1 provides a component-level diagram illustrating a system for applying Bayesian data fusion techniques to multiple sources of sleep data, in accordance with particular embodiments;

The multiple views of FIG. 2 provide flowchart diagrams illustrating processes for applying Bayesian data fusion techniques to sleep data, in accordance with particular embodiments, particularly in which:

FIG. 2A provides a flowchart diagram for a method 200 of applying Bayesian data fusion to multiple sources of sleep data and optionally determining an estimated fatigue level therefrom, in accordance with particular embodiments;

FIG. 2B provides a flowchart diagram for application of a particular Bayesian sleep data fusion algorithm for step 205 of FIG. 2A multiple sources of sleep data, in accordance with particular embodiments, in accordance with particular embodiments;

FIG. 2C provides a flowchart diagram for receiving a plurality of sleep state functions according to a particular method as part of step 201 of FIG. 2A, in accordance with particular embodiments; and

FIG. 2D provides a flowchart diagram for receiving at least one sleep time series according to a particular method as part of step 211 of FIG. 2C, in accordance with particular embodiments;

The multiple views of FIG. 3 provide non-limiting examples of “sleep data” as the term is used in accordance with particular embodiments, specifically in which:

FIG. 3A provides a plot of raw actigraphy data, which may processed as sleep data, according to particular embodiments, or converted into sleep data according to particular embodiments;

FIG. 3B provides a plot showing a sleep time series, which is process as sleep data according to particular embodiments; and

FIG. 3C provides a plot showing a pair of sleep state functions, which are processed as sleep data according to particular embodiments; and

The multiple views of FIG. 4 provide results of Bayesian sleep data fusion algorithm 250 wherein the collected sleep data contains timing errors, in accordance with particular embodiments, specifically wherein:

FIG. 4A provides a plot illustrating the collected sleep data from actigraphy and a sleep diary, alongside the determined consolidated multisource sleep estimate, for a four (4) day period;

FIG. 4B provides a plot illustrating the sleep state functions corresponding to actigraphy and sleep-diary sources for the four (4) day period alongside the multisource sleep estimate; and

FIG. 4C provides a plot illustrating the estimated sleep periods from the four (4) day period with error bars to account for associated uncertainty;

The multiple views of FIG. 5 provide results of Bayesian sleep data fusion algorithm 250 wherein the collected sleep data contains insertion errors, in accordance with particular embodiments, specifically wherein:

FIG. 5A provides a plot illustrating the collected sleep data from actigraphy and a sleep diary, alongside the determined consolidated multisource sleep estimate, for a four (4) day period;

FIG. 5B provides a plot illustrating the sleep state functions corresponding to actigraphy and sleep-diary sources for the four (4) day period alongside the multisource sleep estimate; and

FIG. 5C provides a plot illustrating the estimated sleep periods from the four (4) day period with error bars to account for associated uncertainty; and

The multiple views of FIG. 6 provide results of Bayesian sleep data fusion algorithm 250 wherein the collected sleep data contains deletion errors, in accordance with particular embodiment, specifically wherein:

FIG. 6A provides a plot illustrating the collected sleep data from actigraphy and a sleep diary, alongside the determined consolidated multisource sleep estimate, for a four (4) day period;

FIG. 6B provides a plot illustrating the sleep state functions corresponding to actigraphy and sleep-diary sources for the four (4) day period alongside the multisource sleep estimate; and

FIG. 6C provides a plot illustrating the estimated sleep periods from the four (4) day period with error bars to account for associated uncertainty.

### DETAILED DESCRIPTION

Before the embodiments of the presently disclosed invention are explained in detail, it is to be understood that the invention is not limited in its application to the details of construction and the arrangements of the operative components set forth in the following description or illustrated in the appended drawings. The invention is capable of other embodiments and of being practiced or being carried out in various ways. It is also understood that the phraseology and terminology used herein are for description and should not be regarded as limiting. The use of “including” and “comprising”, and variations thereof, is meant to encompass the items listed thereafter and equivalents thereof. Unless otherwise stated, steps in the methods described can be performed in varying sequences.

### INTRODUCTION

### The Problem of Sleep Data Discrepancies

The presently disclosed invention relies on an array of physiological input data sources which may present conflicting measurements of biological factors. Two important (but non-limiting) data sources that measure the sleep status of an individual are actigraphy-based sleep data and self-reported sleep diary data. These two sleep data sources are commonly used for monitoring astronauts in various space flight missions, for which the presently disclosed invention was developed. (As will be addressed below, however, a multitude of different sleep data sources may be used for the techniques and systems of the presently disclosed invention, which may be applied across various operational settings). One difficulty in using both actigraphy and sleep diary entries to estimate the sleep/wake state of an individual in a real-world operational setting (including space flight) is that frequently the two data sources do not uniformly agree on their measurement of sleep status (i.e., whether the subject is asleep or awake) at a given time. This disagreement between data sources arises from the measurement error associated with each data source. Moreover, these two data sources will also both typically disagree to a certain extent with the scheduled sleep time that may have been planned by an outside manager (such as mission control), even if they are, hypothetically, otherwise errorless in their measurement. That is to say, even highly disciplined astronauts cannot always fall asleep on command.

There has long been felt a need, therefore, to combine these multiple sleep status indication sources (among others) into a single best estimate of the biological factor they are measuring. The presently disclosed invention achieves a data-fusion method that can combine multiple real data sources into (1) an estimate, including (without limitation) a single best estimate, of that biological factor which the data sources are measuring, including (without limitation) sleep state, and (2) an estimation of overall measurement error of that factor, given the individual input sources' measurement errors. Particular embodiments will apply a biomathematical fatigue model to this estimate to determine fatigue and/or alertness states, or any other similar neurobehavioral or neurocognitive state, where sleep status, sleep history, future sleep schedule and/or the like is an input.

The non-limiting data fusion methods developed as part of particular embodiments of the disclosed invention are based largely on a Bayesian estimation framework and use statistical methods and heuristics to combine multiple input data sources into a composite estimate, and simultaneously to track the validity and reliability of the composite estimate. The disclosed invention has been demonstrated to provide a reasonable best estimate of the input data source and the error associated with that estimate under a variety of conditions.

Sleep data (e.g., timing of sleep onset, timing of wake episodes, duration of sleep periods, and/or the like), including sleep history data and prospective sleep schedule data, is an input to the disclosed systems and methods. Accurate and complete sleep information is needed to estimate the individual's current performance state accurately, to estimate trait and state parameters of an associated biomathematical fatigue models, and to predict future levels of fatigue. Sleep timing and duration data are typically available to the presently disclosed systems and methods from one or more data collection methods: wrist-worn actigraphy, sleep diaries, sleep schedules, work schedules, human observation, and/or the like. Each source of data, by itself, provides an estimate of sleep timing and duration. However, each individual data source includes some amount of measurement error, including (without limitation): actigraphy sensors have measurement error associated with uncertain activity levels or states; sleep diaries can contain errors associated with the user estimating the exact times of falling asleep and waking up and omission errors; and sleep schedules can contain missing data errors and discrepancies between scheduled and actual sleep times. The presently disclosed data fusion method combines these data input sources (among others) and provides (without limitation) an estimate of actual sleep that is as accurate and as complete as is reasonably possible given the collected sleep data. Table 1, below, details several common (but non-limiting) causes of data errors associated with different sleep status indication sources.

TABLE 1
SOME TYPICAL CAUSES OF SLEEP MEASUREMENT ERROR

| DATA | ERROR | |
|---|---|---|
| SOURCE | DESCRIPTION | ERROR CAUSES |
| Actigraphy | False Sleep Periods | Subject is sufficiently still such that no movement is detected by the |
| | | actigraph, even though subject is still awake. |
| Actigraphy | False Wake Periods | Subject experiences a bout of restlessness during sleep, and the |
| | | actigraph registers it as a wake episode. |
| Sleep Diary | Missing Entries | Subject fails to make regular diary entries, sometimes for days at a |
| | | time, which are then typically interpreted as extended wake periods. |
| Sleep Diary | General Inaccuracies | Sleep diaries are prone to estimation errors and other discrepancies |
| | | arising from the subject's inability to determine or to recall the |
| | | precise time when he or she fell asleep or woke up. |
| Sleep Schedule | General Inaccuracies | Prescribed sleep schedules may not be followed in practice and may |
| | | therefore bear little or no resemblance to actual sleep history as |
| | | subsequently measured. |
| Work Schedule | General Inaccuracies | Work schedules (and actual work history) may give insight into a |
| | | subject's actual sleep history using a few basic inferences |
| | | (“heuristics”), but work schedules are not always followed, and the |
| | | inferences are not always valid. |
| Performance | General Inaccuracies | Sleep history questions are often posed as part of administering a |
| Test | | performance test. The sleep history may suffer from the same |
| | | inaccuracies as a sleep diary. |
| Direct | General Inaccuracies | While often very good sources of sleep data, the direct observation |
| Observation | | of a sleep subject may also be prone to inaccuracies from faulty |
| | | record keeping, rounding errors, and imprecise timekeeping. |

Reliability and Errors in Sleep Measurement Data

Each source of sleep data has associated with it a measurement error. The specific source and cause of each measurement error, however, depends upon the type of input data stream. For instance, wrist-worn actigraphy devices measure the gross motor activity over a fixed interval of time—i.e., the individual's sleep status is estimated on a moment-by-moment basis based on the amount of activity recorded at that instant. Actigraphy is a non-invasive method of monitoring human rest/activity cycles. A small actigraph unit, also called an “actimetry sensor” or simply “actigraph,” is worn by a subject to measure gross motor activity. Motor activity often under test is that of the wrist, measured by an actigraph in a wrist-watch-like package. The unit continually records the movements it undergoes. The data can be later read to a computer and analyzed offline. In some applications, such as devices commercially sold under the trade names Fitbit™ and WakeMate™, the data is transmitted and analyzed in real time. The unit itself may comprise an electronic device which generally consists of: a piezoelectric accelerometer; a low-pass filter which filters out everything except the 2-3 Hz band, thereby ensuring external vibrations are ignored; a timer to start/stop the actigraph at specific times, and to accumulate values for a specific time frame; a memory to store the resulting values; and an interface, usually USB, serial, or low-power wireless, to program the timer and download the data from memory. Actigraphs have a number of different ways of accumulating the values from the accelerometer in memory. ZCM (“zero crossing mode”) counts the number of times the accelerometer waveform crosses 0 for each time period. PIM (“proportional integral mode”) measures the area under the curve, and adds that size for each time period. TAT (“time above threshold”) uses a certain threshold, and measures the length of time that the wave is above a certain threshold. PIM typically provides the most accurate measurements for both sleep and activity, although the difference with ZCM is reported to be marginal. Non-limiting examples of actigraphy devices comprise those disclosed in U.S. Pat. No. 8,273,035 entitled “Human Biovibrations Method” issued to Russo et al. on Sep. 25, 2012, and U.S. Published Patent Application 2012/0232430 entitled “Universal Actigraphic Device and Method Therefor” submitted by Boissy, et al. on Mar. 10, 2011. All documents cited in this paragraph are hereby incorporated herein in their entirety.

While actigraphy provides an accurate measurement of gross motor activity, the estimation of sleep/wake state from actigraphy data incurs introducing measurement error. Low physical activity and watch-off-wrist times can be misinterpreted as sleep, while excessive movement during sleep can be mistaken for wakefulness. Likewise, sleep diary data is constructed by requiring a user to manually log the sleep he or she receives each night. The accuracy of the sleep and wake times depend on memory and will vary from person to person. Besides errors in recording actual sleep onset or wake-up times, missing entries are a common problem as well, whenever the user forgets to fill in sleep and wake times.

These non-limiting examples of typical measurement errors are generalizable into three categories of sleep data input measurement errors: deletion errors, insertion errors, and timing errors, as identified and described in Table 2, below.

TABLE 2
COMMON SLEEP DATA ERRORS

| ERROR TYPE | DESCRIPTION | NON-LIMITING CAUSES |
|---|---|---|
| Deletion Error | Missing sleep data. Sleep data may have missing | Sleep diaries commonly have missing |
| | entries where entire sleep periods are omitted or | entries because respondents forget to |
| | deleted. | record some sleep periods. |
| Insertion Error | Spurious sleep periods. Sleep data may have | Actigraphy commonly results in additional, |
| | extra sleep periods inserted because of false or | spurious sleep periods whenever the |
| | “ghost” data inserted by measurement devices. | wearer has a period of low physical |
| | | activity. |
| Timing Error | Sleep-wake transition uncertainty. Reported | Sleep diaries rely on the subject to |
| | sleep and wake times are displaced from the | accurately remember the exact times at |
| | actual sleep and wake times by an unknown | which they fell asleep and woke up. |
| | amount of time. | |

Specifically, as used herein, the term “deletion error” shall refer to any error in sleep data reporting wherein a sleep period is mistakenly omitted from the sleep data. Similarly, an “insertion error” shall refer to any error in sleep data reporting wherein a sleep period is mistakenly entered into the sleep data. Likewise, a sleep “timing error” shall refer to any error in sleep data reporting wherein either a sleep-to-wake transition time and/or a wake-to-sleep transition time is mistakenly reported as occurring earlier than or later than the actual transition time.

The Bayesian Sleep Data Fusion System

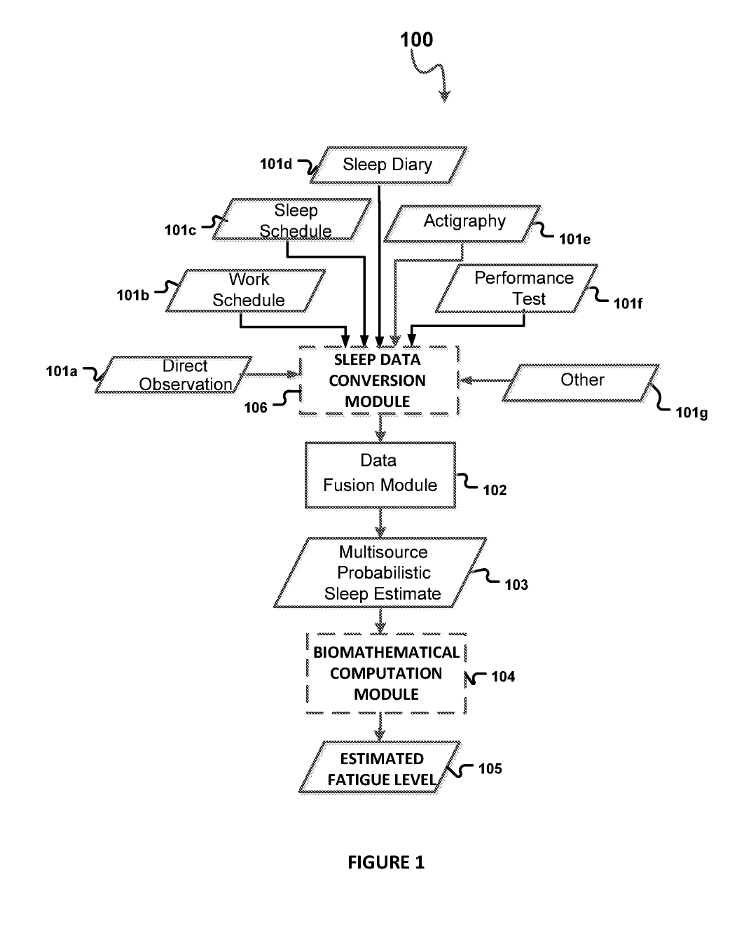

Particular embodiments of the presently disclosed systems and methods attempt to diminish the impact of these sleep-data errors by applying a Bayesian data fusion method to a plurality of sleep data received from a plurality of corresponding sleep status indication sources. FIG. 1 provides a component-level diagram for a non-limiting exemplary system 100 for Bayesian fusion of sleep data, in accordance with particular embodiments. A plurality of sleep status indication sources 101a through 101g are illustrated, specifically (without limitation): direct observation 101a (i.e., a person or camera watches a subject sleep and records the time, and/or the like), a work schedule 101b (i.e., a list of times a subject is scheduled to work, from which inferences about the subject's sleep schedule may be made, and/or the like), a sleep schedule 101c (which may or may not correlate strongly to actual sleep, and/or the like), a sleep diary 101d (i.e., a self-recorded list of sleep times, sleep intervals, and/or wake times made by the subject, and/or the like), actigraphy 101e (i.e., physical activity data recorded by an actigraph device, and/or the like), a performance test 101f (e.g., the PVT, other test of neurobehavioral performance, and/or the like) that includes a questionnaire or other self-report regarding recent sleep activity, other sleep status indication sources 101g, and/or the like. Sleep status data from at least two of these sources 101a-101g is input into the Bayesian data fusion module 102, via optional sleep data conversion module 106 (according to non-limiting particular embodiments), and a multisource probabilistic sleep estimate 103 is determined therefrom.

As used throughout the following discussion and within the appended claims, the term “sleep status indication source” shall refer to any data source from which a subject's sleep status (or an estimate thereof) may be derived, even if the data source does not, strictly speaking, “measure” the sleep status. Various inferences, heuristic rules, and other data analysis techniques (some of which are described at length herein) may be applied to the data source to arrive at the subject's sleep status (or estimate thereof). By way of non-limiting example, a work schedule 101b does not, strictly speaking, “measure” a subject's sleep status, but when certain heuristic rules (as described in connection with Table 3, below) are applied to a work schedule 101b, it may be possible to estimate reliably a subject's sleep schedule. As such, a work schedule 101b is considered a “sleep status indication source” for purposes of the presently disclosed invention. Furthermore, any discrepancies or errors contained within data received from a “sleep status indication source” or derived therefrom shall be referred to in the following discussion and within the appended claims as a “measurement error,” even if, strictly speaking, the error is not one of measurement but rather arises from application of the aforementioned inferences, heuristic rules and/or data analysis techniques.

Bayesian data fusion module 102 and optional sleep data conversion module 106 comprise any one or more components, systems, devices, or mechanisms capable of carrying out a Bayesian statistical calculation and, optionally, converting sleep data to a form ready for such a calculation, respectively. Commonly, but without limitation, Bayesian data fusion module 102 (and optional sleep data conversion module 106) comprises a general purpose computer equipped with non-transitory media (not shown) containing instructions such that when the instructions are executed, the instructions cause the general purpose computer to carry out the steps necessary to execute a Bayesian data fusion. Such an embodiment of module 102 (and optionally module 106) may comprise any type of general purpose computer known in the art—including (without limitation), a personal computer, a desktop computer, a mobile computing device (e.g., PDA, cellular phone, tablet computer), a distributed computing network (including one or more intranets and/or the Internet), an embedded device, a microprocessor or microcontroller, and/or the like.

Multisource probabilistic sleep estimate 103 comprises any output capable of conveying a subject's prior sleep history based on sleep-data input. Multisource probabilistic sleep estimate 103 may comprise (without limitation): a report, a function of sleep status over time, a binary function of sleep status over time, a probability function of sleep status over time, and/or the like. When expressed as a probability function of sleep status over time, multisource probabilistic sleep estimate may, according to particular embodiments, comprise a multisource likelihood of sleep function P_{M}(sleep) and/or a multisource likelihood of wake function P_{M}(wake), expressing the probability that the subject is or was asleep or is or was awake at a given time, respectively, as determined by the plurality of sleep status indication sources 101a through 101g.

Particular embodiments may also estimate the individual's fatigue state by using the multisource probabilistic sleep estimate as an input to a mathematical fatigue model. System 100 provides optional components for such embodiments. Specifically, biomathematical computation module 104 comprises a computational module that is capable of applying a mathematical fatigue model to the multisource probabilistic sleep estimate 103 to determine, as output, an estimated fatigue level 105 for the individual. Biomathematical computation module comprises any component, system, device, or mechanism capable of applying a biomathematical fatigue model. Commonly, but without limitation, biomathematical computation module 104 comprises a general purpose computer equipped with non-transitory media (not shown) containing instructions such that when the instructions are executed, the instructions cause the general purpose computer to carry out the steps necessary to execute a Bayesian data fusion. Such an embodiment of module 104 may comprise any type of general purpose computer known in the art—including (without limitation), a personal computer, a desktop computer, a mobile computing device (e.g., PDA, cellular phone, tablet computer), a distributed computing network (including one or more intranets and/or the Internet), an embedded device, a microprocessor or microcontroller, and/or the like.

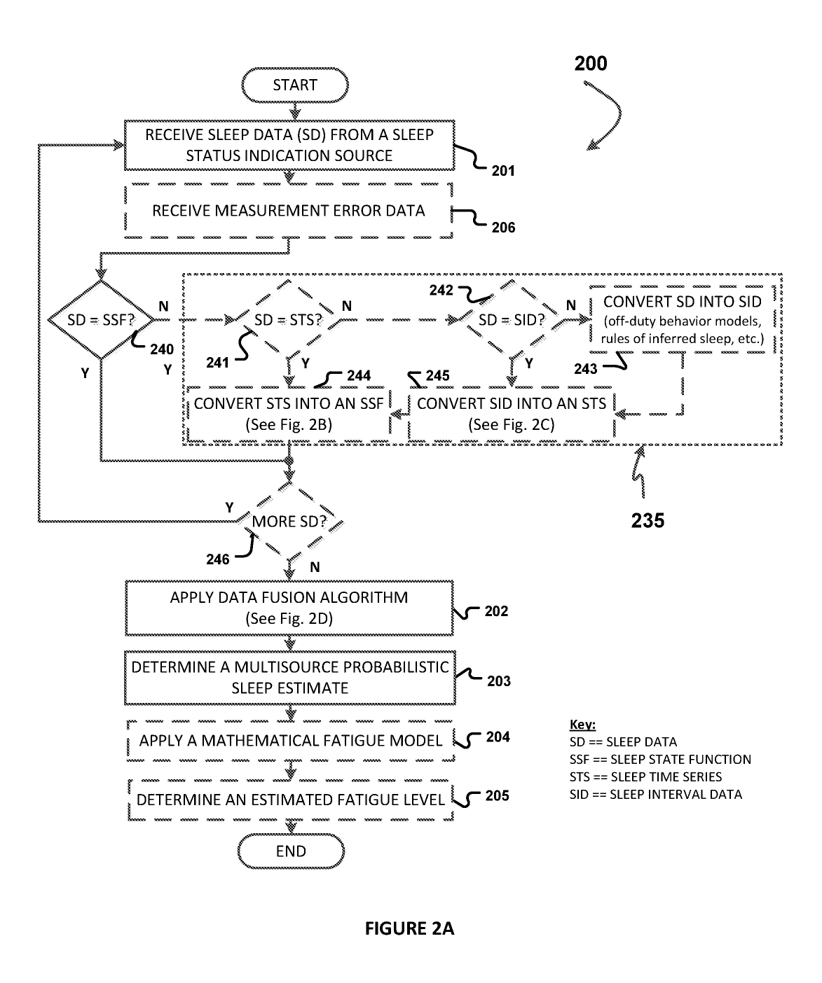

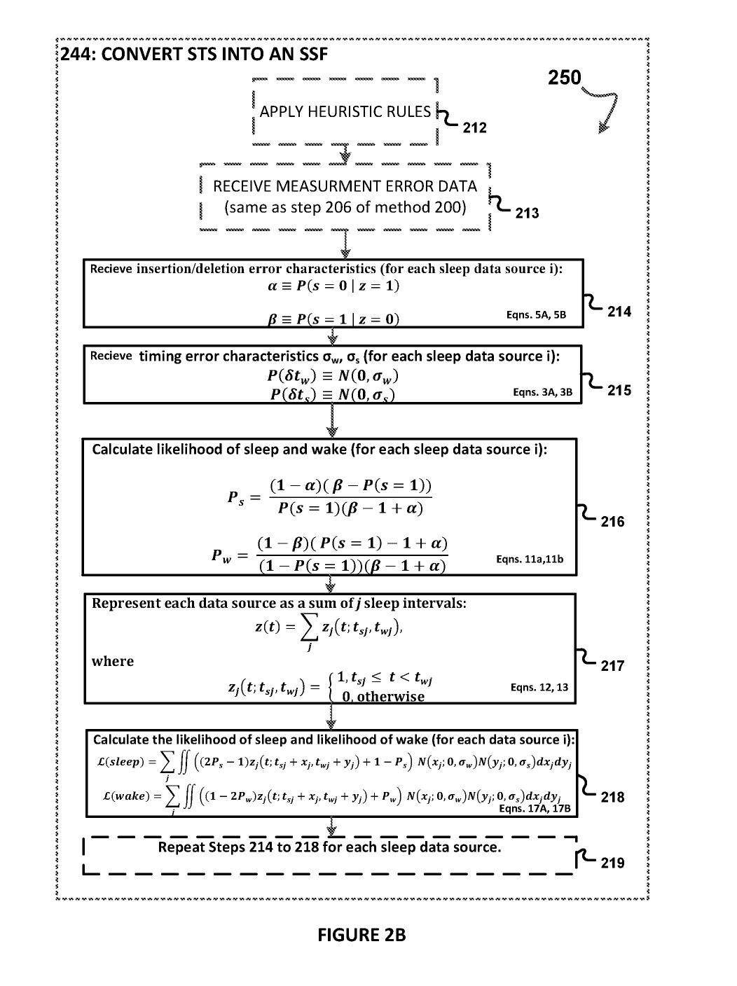

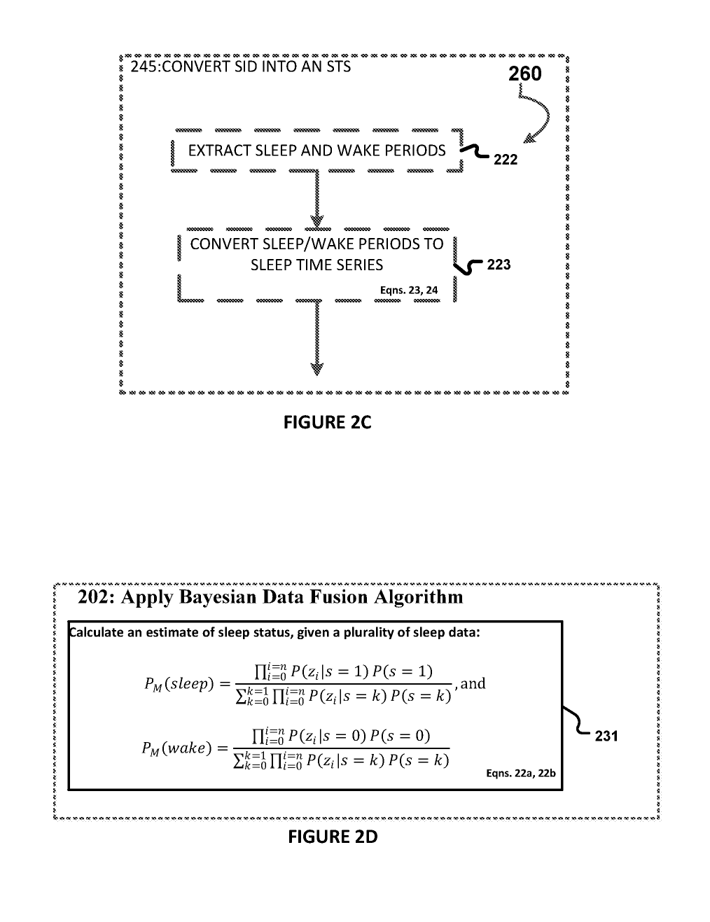

For the sake of organization, details regarding the biomathematical fatigue models applied by mathematical computation module 104, and regarding the nature of an estimated fatigue level 105, are addressed in connection with optional steps 204 (applying a mathematical fatigue model) and 205 (determining an estimated fatigue level) of method 200 (FIG. 2A), below, respectively.

The multiple views of FIG. 2 provide flowchart diagrams illustrating non-limiting methods for applying Bayesian fusion techniques to sleep data, in accordance with particular embodiments. In particular, FIG. 2A provides a flowchart diagram illustrating a method 200 for applying Bayesian data fusion techniques to sleep data, in accordance with particular embodiments. In step 201 sleep data is received from a one or more sleep status indication sources 101, including but not limited to sleep status indication sources 101a-101g (FIG. 1). Step-201 received sleep data comprises data that directly or indirectly indicates a sleep-wake status of the individual at one or more times. Non-limiting examples of step-201 received sleep data include: reports of sleep and wake intervals, reports of sleep onset and duration times, work history or work schedule data (from which sleep times may be inferred), sleep state functions such as (without limitation) sleep time series and/or sleep state functions (as those terms are defined herein below), raw actigraphy data, actigraphy data analyzed (or “scored”) for sleep intervals, actigraphy data converted to sleep time series, reported sleep status probabilities, various performance data (e.g., neurobehavioral or neurocognitive test performance data, such as data from the psychomotor vigilance task/test, and/or the like) from which recent sleep history may be inferred under some circumstances and/or which may come with optional reported sleep data, and/or the like. Step-201 received sleep data may be formatted in any manner acceptable for reporting sleep, such as (without limitation) a set of sleep onset and wake up times, a list of sleep or wake intervals according to clock time, a set of sleep or wake intervals according to duration, functions of sleep status reported as a function of a continuous or discrete time variable, a binary sleep function of a continuous or discrete time variable wherein sleep status is reported only as one of two binary states (i.e., “sleep” or “wake,” optionally identified respectively as “1” or “0” or vice versa) and/or the like. For particular sleep status indication sources (e.g., actigraphy), pre-processing may be necessary to convert output from the sleep status indication source to generate step-201 received sleep data. Various algorithms and techniques as are known in the art may be used for such purposes. Particular embodiments may reformat the step-201 received sleep data to conform to one or more conventional data formats (e.g., sleep functions, binary sleep functions, sums of sleep intervals, etc.). It is to be understood throughout the following discussion, and in the appended drawings and claims, that a reformatting of step-201 received sleep data under these circumstances does not fundamentally alter the sleep data's character as sleep data. All such formats, whether as received by system 100 or subsequently formatted to by system 100, are to be considered “sleep data” as the term is used herein.

In particular embodiments, step-201 received sleep data may correspond to the sleep state of one or more individuals as measured during a critical time period or other time interval of interest. The time interval of interest may correspond to a work interval (i.e., a time period when the one or more individuals are assigned to be working), the time period of a discrete military operation, the time period of an assigned space flight, the time period of an extra-vehicular activity during a space flight (i.e., a space walk outside a space-flight vehicle), an observation period for medical or scientific research, and/or the like. According to particular embodiments, any time period in which an individual's sleep status may be of importance to determining, without limitation, a future fatigue state for the individual may be used as a time period of interest for the sake of the presently disclosed invention. In such cases, the time period of interest may also be called (without limitation) a “critical fatigue period.” Method 200 may then proceed to optional step 206, wherein measurement error data is received, in accordance with particular embodiments. Step-206 received measurement error data comprises any data capable of expressing a measurement error within the sleep data received in step 201. Without limitation, step-206 received measurement error data may comprise data indicative of the accuracy of one or more aspects of sleep data, including but not limited to the timing of sleep/wake state transitions, and the certainty of a sleep/wake state value. A non-limiting example of step-206 received measurement error data comprises error characteristics related to so-called “insertion” and/or “deletion” errors, such characteristics expressing the degree to which the corresponding sleep status indication source may or may not properly report the inclusion or exclusion of a sleep interval, respectively. Such insertion and deletion error characteristics may be expressed as a pair of constants, α and β, which express the false positive tendencies and the false negative tendencies, respectively, of the sleep status indication source, as described in more detail below in connection with step 214 of method 250 (see FIG. 2B) and as discussed above in connection with Table 2. Another non-limiting example of step-206 received measurement error data comprises sleep timing error characteristics which report the degree to which a sleep data source accurately reports a sleep-to-wake or a wake-to-sleep transition time. The magnitude of such timing errors δt (i.e., how long before or after the actual transition time is the measured transition time reported to be) may be modeled by normal (i.e., Gaussian) distributions N with a zero mean and a constant standard deviation σ, according to particular embodiments, as discussed in more detail below in connection with step 215 of method 250 (see FIG. 2B) and as discussed above in connection with Table 2. Other suitable distribution functions could be substituted for the normal distribution. According to particular embodiments, one or more of the step-206 received measurement error characterisitcs (including without limitation α, β, σ, and δ) may be time-variant to reflect changes in measurement certainty that vary over the timeframe of data collection. (For simplicity, only the time invariant embodiments are discussed in full here).

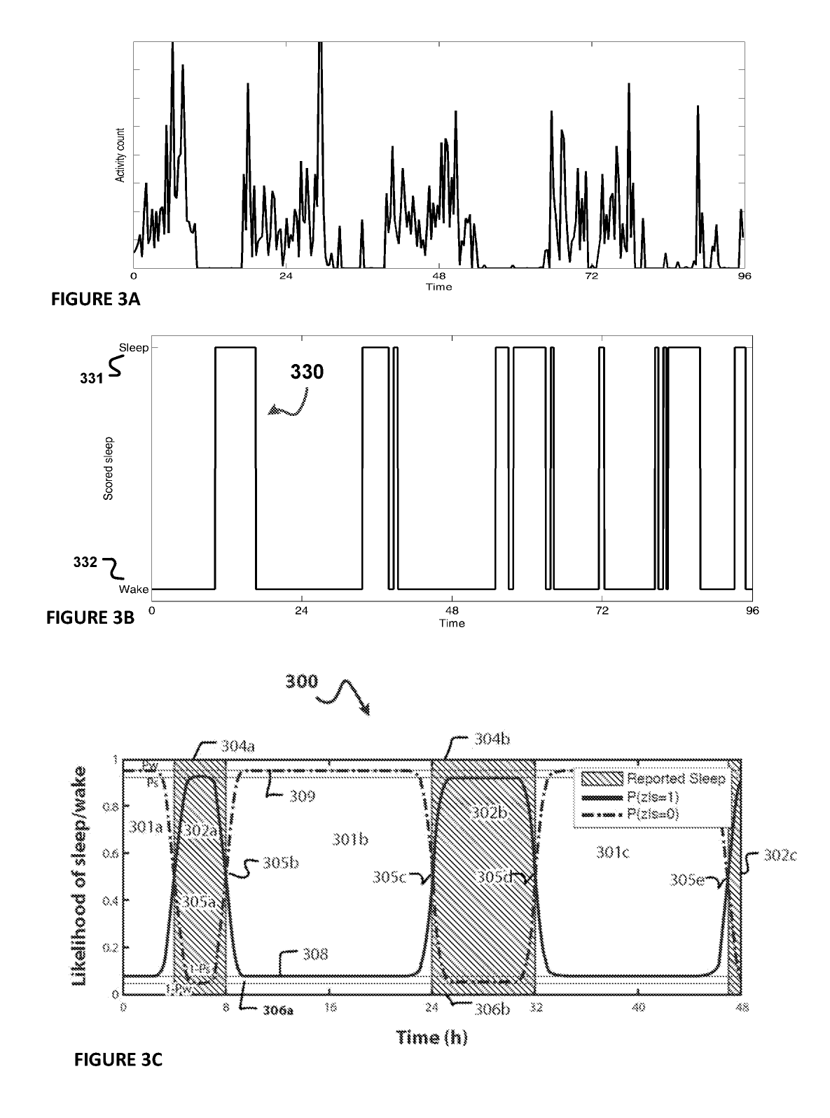

Since step-201 received sleep data may comprise many forms, particular embodiments of method 200 may comprise one or more optional steps to convert the step-201 received sleep data into a form suitable for application of a Bayesian data fusion algorithm. Optional sleep data conversion subprocess 235 (comprising steps 241 to 245) fills that role, in accordance with particular embodiments. Query step 240 determines whether to invoke sub-process 235, based on whether the step-201 received sleep data is already formatted suitably for the application of a Bayesian data fusion algorithm—specifically as a “sleep state function.” (A “yes” answer bypasses data conversion in subprocess 235; a “no” invokes it). A sleep state function, such as that tested-for by query step 240, comprises a set of likelihood functions—denoted [symbol] (sleep) and [symbol] (wake) (or, equivalently, [symbol] ₛₗₑₑₚ(t) and [symbol] _{wake}(t) to, occasionally, denote their time dependence) and called the “likelihood of sleep” and the “likelihood of wake,” respectively—representing the likelihood of an individual being awake or asleep at one or more times during a relevant time period as determined by a particular sleep status indication source but adjusted for the source's measurement error. Functions 308 and 309 of FIG. 3B comprise non-limiting examples of a sleep state function (as used in query step 240) in accordance with particular embodiments. According to particular embodiments, a sleep state function may comprise a function of a discrete time variable, may be bounded by an upper value and a lower value (representing two binary sleep states—i.e., “awake” or “fully awake” on the one hand, and “asleep” or “fully asleep” on the other), and/or may comprise any one or more intermediate values between the upper and lower values (representing degrees of alertness between “fully awake” and “fully asleep”). In particular embodiments (not shown), a sleep state function may comprise a single function reflecting the likelihood of sleep adjusted for timing errors, from which the likelihood of wake may be determined as the reciprocal of the likelihood of sleep. In particular embodiments (not shown), a sleep state function may comprise a single function reflecting the likelihood of wake adjusted for timing errors, from which the likelihood of sleep may be determined as the reciprocal of the likelihood of wake. In particular embodiments, upper and lower values may comprise 0 and 1, and the sleep state function may assume values between 0 and 1.

Subprocess 235 proceeds to optional query step 241, where process flow is dictated by whether the step-201 received sleep data is already formatted as a sleep time series. (A “yes” answer leads to step 244 where sleep time series are converted into sleep state functions; a “no” answer leads to another query in the subprocess). A sleep time series, comprises one or more sleep time points, each time point comprising a time value and a sleep category value. The category value may be one of at least two categories, wherein a first category, or value, (e.g., “sleep” category 331) represents a state of being asleep for the individual, wherein a second category, or value represents (e.g., “wake” category 331), a state of being awake for the individual. In some embodiments one or more additional (but optional) categories represent possible intermediate states of alertness between being “asleep” and “awake,” such as various techniques for distinguishing sleep stages—e.g., two values or categories representing REM vs. non-REM sleep; up to five values or categories representing Sleep Stage 1 (high alpha and theta waves), Sleep Stage 2 (“sleep spindles”), Sleep Stage 3 (transition to delta waves), Sleep Stage 4 (delta waves), and Sleep Stage 5 (REM sleep); and/or the like. In particular embodiments the sleep time series is a binary function (i.e., only two values), and in particular embodiments, the binary function takes only values of 0 and 1, which can represent sleep and wake states, respectively—or, according to other embodiments, vice versa. A non-limiting example of a sleep time series, in which there are two categories (sleep and wake) is the sleep time series 330 of FIG. 3B. If the step-201 sleep data is a sleep time series, then process flow passes to optional step 244, wherein the sleep time series is converted into a sleep state function, in accordance with the method discussed in connection with step 244 (see FIG. 2C, below). If not, subprocess 235 proceeds to optional query step 242.

If subprocess 235 continues into optional query step 242, process flow is dictated by whether the step-201 received sleep data comprises sleep interval data. (A “yes” answer leads to step 245 where sleep interval data are converted into sleep time series; a “no” answer leads to step 243 where any remaining sleep data are converted into sleep interval data before being converted to sleep time series in step 245.) Sleep interval data comprises any data (other than a sleep state function or a sleep time series) that indicates one or more time intervals in which a subject is sleeping, in accordance with particular embodiments. Non-limiting examples of sleep interval data comprise: recorded sleep intervals from a sleep diary or from direct observation of sleep, sleep intervals from a work or sleep schedule, and/or the like.

If the step-201 received sleep data comprises sleep interval data, subprocess 235 proceeds to step 245 wherein it is converted into a sleep time series in accordance with the method discussed in connection with FIG. 2C, below. Tables 4A and 4B (below) provide non-limiting examples of sleep interval data, in which wake and sleep times are recorded and in which sleep times and sleep durations are recorded, respectively.

TABLE 4A
Sample Sleep Interval Data (wake and sleep times recorded)

| Date | Wake Time | Sleep Time |
|---|---|---|
| Day 1 | 06:15:22 | 22:05:33 |
| Day 2 | 06:38:42 | 22:07:40 |
| Day 3 | 07:05:22 | 22:15:11 |

Table 4A reflects sleep interval data comprising a time of wake onset (or “wake time”) corresponding to when a subject arises awakes from sleep, and a time of sleep onset (or “sleep time”) corresponding to when a subject goes or falls to sleep. The interval between these two times (e.g., the time between 06:38 and 22:07:40 on Day 2 in Table 4A) comprises a wake interval. Sleep intervals may also be inferred from such data (e.g., the time between 22:05:33 on Day 1 and 06:38:42 on Day 2, assuming the days indicated are consecutive calendar days).

TABLE 4B
Sample Sleep Interval Data (sleep
times and sleep durations recorded)

| Date | Sleep Time | Sleep Duration |
|---|---|---|
| Day 1 | 22:05:33 | 7:53 |
| Day 2 | 22:07:40 | 8:16 |
| Day 3 | 22:15:11 | 9:22 |

Table 4B reflects sleep interval data comprising a sleep onset time and a sleep duration. From this table sleep intervals can be immediately determined (i.e., the subject slept for 7 hours and 53 minutes starting at 22:05:33, or 10:05:33 PM, on Day 1). Conversely, wake intervals may also be inferred from such data—e.g., on Day 2, the subject was awake from 05:58:33 (a wake time ascertained by deduction using the sleep time and sleep duration Day 1's entries) to 22:07:40.

If the step-201 received sleep data does not comprise sleep interval data, process flow proceeds to step 243 wherein the step-201 received sleep data is converted into sleep interval data before proceeding to step 245 and conversion to a sleep time interval. Tables 5A and 5B (below) illustrate how step-201 received sleep data that is not in any of the prescribed forms (e.g., a sleep state function, a sleep time series, or sleep interval data) may be converted into sleep interval data, according to particular embodiments. Specifically, Table 5A provides “sleep data” in the form of a routine work schedule for a subject, who works a regular day shift from 9:00 AM to 5:00 PM every day, for a subject who works a night shift from 7:00 PM to 2:00 AM the next day, and for a subject who works a graveyard shift from midnight to 9:00 AM the next day.

TABLE 5A
Sample Work Data (work start and end times recorded)

| Schedule Type | Work Start | Work End |
|---|---|---|
| Regular Day | 09:00:00 (9:00 AM) | 17:00:00 (5:00 PM) |
| Night Shift | 19:00:00 (7:00 PM) | 02:00:00 (next day) |
| Graveyard Shift | 00:00:00 (midnight) | 09:00:00 (next day) |

Conversion of step-201 received sleep data into sleep interval data in step 243 comprises any method, technique or procedure whereby sleep data—but not comprising one or more of sleep state functions, sleep time series, or sleep interval data—may be converted into sleep interval data. A non-limiting example of a step-243 conversion comprises applying one or more off-duty behavioral models to work schedule or work history data. Off-duty behavioral models comprise any rule or technique whereby an individual's off-duty sleep behavior may be inferred by his or her work schedule or work history—e.g., a rule that posits an individual will sleep for an 8 to 10 hour interval ending two hours before a standard morning work shift; a rule that posits an individual will sleep during the longest off-duty period available, and/or the like.

TABLE 5B
Sleep Interval Data (work start and end times recorded)

| Date | Work Start | Work End | Possible Inferred Sleep Interval |
|---|---|---|---|
| Day 1 | 09:00:00 | 17:00:00 | n/a—insufficient data |
| Day 2 | 09:00:00 | 17:00:00 | 10:00 PM of Day 1 to 6:00 AM |
| | | | of Day 2 |
| Day 3 | 09:00:00 | 17:00:00 | 10:00 PM of Day 2 to 6:00 AM |
| | | | of Day 3 |

Table 5B provides a non-limiting example of the application of a common rule of inference applied to the data of Table 5A—i.e., that an individual will sleep for an 8-hour period ending 2 hours prior to a regularly scheduled workshift. Another non-limiting example of a rule of inference comprises: estimating behavior before and after work using a mathematical model to determine wake periods, classifying remaining time periods as possible sleep periods, and then applying a model-based prediction of sleep propensity to determine a most likely sleep time within the possible sleep periods.

Upon exiting optional subprocess 235, flow passes to optional step 246, which either redirects flow depending upon the existence of more sleep data to be processed: back to step 201 (receive sleep data) if “yes,” or on to step 202 (discussed below) if “no.”

Method 200 then continues in step 202, wherein a Bayesian data fusion method, such as one of the many described herein, is applied to one or more of sleep state functions—either as received in step 201 (as sleep data) or as converted in step 244 (from a sleep time series). A step-202 data fusion algorithm includes any mathematical formula, recipe, technique, rule, algorithm, inference, or any set or combination of the foregoing that includes applying Bayesian statistical analyses to sleep data. Bayes' Theorem (or, equivalently, at least as used herein, “Bayes' Rule” or “Bayes' Law”) expresses how a subjective degree of belief should change to account for new evidence. Mathematically, it can be expressed as P(A|B)=P(B|A) (P(A)|P(B)), where P(A|B) represents the probability of condition A obtaining given that condition B has obtained, where P(B|A) represents the probability of B obtaining given that A has obtained, and where P(A) and P(B) are the possibilities of conditions A and B obtaining independently of one another, respectively. A useful and readily accessible account of Bayes' Theorem can be found in E. S. Yudlowsky, “An Intuitive Explanation of Bayes' Theorem,” available at www.yudlowsky.net/rational/bayes (last visited Jan. 10, 2013), the entirety of which is incorporated herein by reference.

The result of the step-202 application of a Bayesian data fusion algorithm to the one or more sleep state functions (from step 201 or step 244) is a multisource probabilistic sleep estimate, which is determined in step 203. A step-203 determined multisource probabilistic sleep estimate provides, according to particular embodiments, an estimate of an individual's sleep-wake status over time as determined in light of the sleep data received in step 201 from one or more sleep data sources and accounts for measurement error associated with each of those data sources. According to particular embodiments, the step-203 determined multisource probabilistic sleep estimate may comprise a single best estimate of sleep-wake status. In particular embodiments, the step-203 determined multisource probabilistic sleep estimate may comprise a probability function of a discrete time variable. In particular embodiments, the step-203 determined multisource probabilistic sleep estimate may also comprise at least in part uncertainty information (such as one or more statistical parameters, a confidence interval, and/or the like) wherein the magnitude of the multisource probabilistic sleep estimate may comprise a measure of centrality (e.g., average, mean, median, mode, etc.) of the statistical probability of sleep-wake status, and the uncertainty associated therewith may comprise a measure of spread (e.g., standard deviation, variance, a confidence interval, etc.) of the statistical probability of sleep-wake status. Variations of the foregoing, as are known in the art, may be used by particular embodiments.

Method 200 may then proceed to optional step 204, wherein a mathematical fatigue model is applied to the step-203 determined multisource probabilistic sleep estimate. An optional step-204 applied mathematical fatigue model may comprise any neurobehavioral performance model used to determine future fatigue and/or alertness levels based at least in part upon a determined sleep status, or a sleep status across time, as input. Among the neurobehavioral performance models utilized by the presently disclosed invention as an optional step-204 applied mathematical fatigue model, particular embodiments may utilize the so-called “two-process model” of sleep regulation developed by Borbèly et al. in 1999. The Borbèly two-process model posits the existence of two primary regulatory mechanisms: (i) a sleep/wake-related mechanism that builds up exponentially during the time that the subject is awake and declines exponentially during the time that the subject is asleep, and is called the “homeostatic process” or “process S;” and (ii) an oscillatory mechanism with a period of (nearly) 24 hours, which adjusts for naturally occurring biorhythmic oscillations in the fatigue state, called the “circadian process” or “process C.” Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures. Total alertness at a given time y(t), which is one non-limiting example of neurobehavioral performance, may then be represented as a sum of the C and S processes (see, e.g., Equation 1(c), below).

Further details related to applying the Borbèly two-process fatigue model are contained in PCT published patent application, entitled “Systems and Methods for Individualized Alertness Predictions,” submitted by inventors Mott, C. G., Mollicone, D. J., et al., and published as WIPO publication No. WO 2009/052633, the entirety of which is incorporated herein by reference and from which portions of the following discussion are excerpted for convenience and clarity.

In accordance with the two-process model, the circadian process C may be represented by:

$$C ( t ) = γ {\sum }_{l = 1}^{5} {a}_{l} sin ( 2 l π ( t - ϕ ) / τ ) \qquad ( 1 a )$$

where t denotes clock time (in hours, e.g. relative to midnight), φ represents the circadian phase offset (i.e. the timing of the circadian process C relative to clock time), γ represents the circadian amplitude, and τ represents the circadian period which may be fixed at a value of approximately or exactly 24 hours. The summation over the index l allows for harmonics in the sinusoidal shape of the circadian process. For one particular application of the two-process model for alertness prediction, l has been taken to vary from 1 to 5, with constants aₗ being fixed at a₁=0.97, a₂=0.22, a₃=0.07, a₄=0.03, and a₅=0.001.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefulness \\ {e}^{- {ρ}_{w} Δ t} {S}_{t - Δ t} & if during sleep\end{matrix} \qquad ( 1 b )$$

(S>0), where t denotes (cumulative) clock time, Δt represents the duration of time step from a previously calculated value of S, ρ_{w} represents the time constant for the build-up of the homeostatic process during wakefulness, and ρₛ represents the time constant to recover the homeostatic process during sleep. Given equations (1a) and (1b), the total alertness according to the two-process model may be expressed as a sum of: the circadian process C, the homeostatic process S multiplied by a constant scaling factor κ, and an added noise component ε(t), or:

y(t)=κS(t)+C(t)+ε(t) (1c)

It is useful to describe the homeostatic process S for a test subject after one or more transitions between being asleep and being awake. The sleep-wake transitions are commonly (but without limitation) represented as square wave signals oscillating between the binary states of being asleep (value=1 herein, without limitation) and being awake (value=0 herein, without limitation), referred to as binary sleep functions (see, e.g., discussion of step 202 of method 200, FIG. 2A, above). Other mathematical representations of sleep status and effectiveness may be utilized by particular embodiments.

Other non-limiting examples of step-204 applied mathematical fatigue models include a modified two-process model that attempts to capture the accumulation of impairment across days of sleep restriction by incorporating a linear accumulation function in the homeostatic asymptotes. This is accomplished by adding two new parameters to the two-process model, M_{w} and Mₛ, which modify the homeostatic asymptote κ according to the following:

$$\begin{matrix}S ( t ) = \{ \begin{matrix}{e}^{- {ρ}_{W} Δ T} {S}_{t - Δ T} + ( 1 - exp ( - {ρ}_{W} Δ T ) ) & during wake \\ {e}^{- {ρ}_{s} Δ T} {S}_{t - Δ T} & during sleep\end{matrix} & ( 1 a ) \\ C ( t ) = γ {\sum }_{l = 1}^{5} {a}_{l} sin ( 2 l π ( t - ϕ ) / τ ) & ( 1 b ) \\ y ( t ) = κ ( t ) S ( t ) + C ( t ) & ( 1 d ) \\ κ ( t ) = \{ \begin{matrix}{κ}_{t - Δ T} + {M}_{W} Δ T & during wake \\ {κ}_{t - Δ T} + {M}_{S} Δ T & during sleep\end{matrix} & ( 1 e )\end{matrix}$$

Another (non-limiting) step-207 applied mathematical fatigue model utilizes significant cross-correlation between M_{w} and Mₛ in the circadian, homeostatic, and chronic effects, and further simplifies the model to a reduced-order chronic model. By combining the rate parameters M_{w} and Mₛ into a single parameter M_{c}. This new model may be defined as:

$$\begin{matrix}S ( t ) = \{ \begin{matrix}{e}^{- {ρ}_{W} Δ T} {S}_{t - Δ T} + ( 1 - exp ( - {ρ}_{W} Δ T ) ) & during wake \\ {e}^{- {ρ}_{s} Δ T} {S}_{t - Δ T} & during sleep\end{matrix} & ( 1 a ) \\ C ( t ) = γ {\sum }_{l = 1}^{5} {a}_{k} sin ( 2 π l ( t - φ ) / τ ) & ( 1 b ) \\ y ( t ) = κ ( t ) S ( t ) + C ( t ) & ( 1 d ) \\ κ ( t ) = \{ \begin{matrix}{κ}_{t - Δ T} + 0.604 {M}_{C} Δ T & during wake \\ {κ}_{t - Δ T} + ( 0.797 {M}_{C} - 0.093 ) Δ T & during sleep\end{matrix} & ( 1 f )\end{matrix}$$

Additional fatigue models may be utilized by particular embodiments as the step-204 applied mathematical fatigue model. Other non-limiting examples include (without limitation): Akerstedt's “three-process model of alertness” (see, e.g., Akerstadt, T., et al. “Predictions from the Three-Process Model of Alertness,” Aviation, Space, and Environmental Medicine, 75:No. 3, §II (March 2004); see also Akerstedt, T. et al. “A Model of Human Sleepiness,” excerpted from Sleep '90 J. Home, Ed. (Pontenagel Press 1990)); Achermann's “two-process model revisited” (see e.g., Achermann, P., “The Two-Process Model of Sleep Regulation Revisited,” Aviation, Space, and Environmental Medicine, 75:No. 3, §II (March 2004)); Avinash's “process-U model” (see Avinash, D., “Parameter Estimation for a Biomathematical Model of Psychomotor Vigilance Performance under Laboratory Conditions of Chronic Sleep,” Sleep-Wake Research in the Netherlands 16:39-42 (Dutch Society for Sleep-Wake Research 2005); Beersma's “modified two-process model” (see, e.g., Beersma, D. G. M., “Models of Human Sleep Regulation,” Sleep Medicine Reviews 2:No. 1, pp. 31-43 (W. B. Saunders Co. Ltd. 1998)); Belyavin and Spencer's “QinetiQ Approach” (see, e.g., Belyavin, A. J. and Spencer, M. B., “Modeling Performance and Alertness: the QinetiQ Approach,” Aviation, Space, and Environmental Medicine, 75:No. 3, §II (March 2004)); the “circadian alertness simulator” (see, e.g., Dijk, D. J., et al. “Fatigue and Performance Models General Background and Commentary on the Circadian Alertness Simulator for Fatigue Risk Assessment in Transportation,” Aviation, Space, and Environmental Medicine, 75:No. 3, §II (March 2004)); the so-called “new model class” (see, e.g., McCauley, P., et al, “A new mathematical model for the homeostatic effects of sleep loss on neurobehavioral performance,” Journal of Theoretical Biology, 256:227-239 (Reed-Elsevier 2009)); alternative models such as nonparametric approaches and neural networks (see, e.g., Reifman, J., “Alternative Methods for Modeling Fatigue and Performance,” Aviation, Space, and Environmental Medicine, 75:No. 3, §II (March 2004)); and/or the like. Particular embodiments of the presently disclosed invention may make use of any one or more biomathematical models described in the aforementioned references or various combinations and/or equivalents. All of the publications referred to in this paragraph are hereby incorporated by reference herein.

Method 200 may then proceed to optional step 205, wherein an estimated fatigue level is determined from the step-204 applied mathematical fatigue model and the step-203 determined multisource probabilistic sleep estimate. An optional step-205 determined estimated fatigue level provides an estimated fatigue and/or alertness level for the individual at one or more future times, based at least in part on the multisource probabilistic sleep estimate determined in step 203. An optional step-205 determined fatigue level may also comprise any measure or metric whereby an individual's neurocognitive or neurobehavioral performance level may be quantified. As such, as used herein the term “fatigue” includes, without limitation, any functional or morophological change to any neurobehavioral state, resulting in a diminished capacity to perform a task. Fatigue may change as a function of time of day, time, time on task, repetitions of task, age, disease state, drug consumption or concentration, associated motivational factors, and/or the like. Drugs and other therapies that may modify fatigue. Fatigue may result from the following fatigue stressors: sleep disruption, sleep restriction, circadian misalignment, sleep inertia, extended task performance or duty hours, multitasking, (extended) physical exertion, psychological stress (examples: time pressure; family, legal, or financial problems; etc.), environmental stressors (may include: extreme temperature or humidity conditions, ambient noise, machine vibration, light conditions, altitude “hypoxia,” medical conditions or behavioral disorder that contributes to modification of state or trait, examples: Parkinsons, Alzheimer's, dementia, or any age-related brain dysfunction or mild cognitive impairment, brain injuries, any cognitive brain disorder or impairment, mood disorders or psychoses (narcissism, schizophrenia, etc.), and/or the like. To determine an optional step-205 estimated fatigue level according to the broad definition of “fatigue” used herein, additional biomathematical models may be applied by particular embodiments in optional step 204 that determine “fatigue” as the term is broadly defined throughout the foregoing discussion.

Mathematical Derivation of Probabilistic Models of Sleep Estimation

With a broad overview of method 200 completed, attention may now turn to particulars of the step-202 applied Bayesian data fusion, including (without limitation) that algorithm of FIG. 2B in accordance with particular embodiments. As noted above, a step-202 Bayesian data fusion algorithm may encompass a broad array of mathematical and statistical techniques. A step-202 applied Bayesian data fusion algorithm encompasses any method that applies Bayes' Theorem (or Bayes' Law or Bayes' Rule—used as synonyms herein) to the estimation of sleep state based on the output of one or more sleep data sources, which includes, but is not limited to the specific methods described herein.

FIG. 2B provides a flowchart illustrating an exemplary but non-limiting method 250 for converting a sleep time series into a sleep state function, in accordance with particular embodiments. (Other methods may be used to convert sleep time series into sleep state functions as part of step 244 of method 200).

Method 250 commences in optional step 212 in which so-called heuristic rules are applied to sleep state functions in order to address common scenarios of data confusion. A step-212 applied heuristic rule comprises any technique, method, “trick-of-the-trade,” “rule-of-thumb” by which sleep time series are modified to account for common data errors. Table 5 (below) provides several non-limiting examples of heuristic rules.

TABLE 6
EXEMPLARY HEURISTIC RULES

| NAME | DESCRIPTION |
|---|---|
| Insert Likely Sleep Intervals | Typically used when sleep diary data is missing entries. Sleep intervals may be |
| | inserted into the sleep data (or sleep function) according to a given set of |
| | parameters-e.g., 8 hour sleep interval every 24 hours starting at 10:00 PM. |
| | These inserted sleep intervals may be marked as unreliable. |
| Delete “False Naps” | Typically used when actigraphy inserts short sleep periods in the middle of long |
| | wake periods. Deletion may occur according to a particular set of parameters- |
| | e.g., delete all sleep intervals of less than one hour when occurring with at least |
| | two hours of wake both before and after. These deleted “false naps” may be |
| | marked as unreliable. |
| Smooth Discontinuous Sleep | Typically used when actigraphy shows short interruptions in the middle of a |
| | long sleep interval. Smoothing may occur according to a particular set of |
| | parameters-e.g., remove all wake periods of less than half an hour when an |
| | hour or more of sleep exists both before and after these sleep periods. |
| Replicate Recent Prior Sleep | Typically used when sleep diaries are missing several consecutive entries. |
| History | Sleep intervals may be inserted based upon the sleep history immediately |
| | preceding the missing data. |
| Infer Sleep Schedule from Work | Typically used when work schedule or work history data is provided. Sleep |
| Schedule | may be inferred from the work schedule according to a particular rule or a set of |
| | parameters-e.g., assume a sleep period of between 6 and 8 hours that ends 2 to |
| | three hours before each work shift, if the subject works days. (Conversely, |
| | according to particular embodiments, work history/schedule data may also be |
| | converted to another set of sleep history/schedule data, using heuristics, and |
| | treated as another source of sleep data.) |

According to particular embodiments, inferences of sleep status from work schedules may be made as part of a step-212 applied heuristic rule, particularly when the step-201 received sleep data is received in a sleep time series form. According to other embodiments, inferences of sleep status may be made as part of other steps in methods 200, 250, and/or 260, depending upon the variety of sleep data received in step 201.

Method 250 may continue in optional step 213 wherein measurement error data may be received for the sleep time series being converted in process 250. Optional step-213 received measurement error data comprises the same measurement error data discussed in connection with step 206 of method 200 (FIG. 2A). Particular embodiments may receive the measurement error data in step 206, whereas other embodiments receive the measurement error data in step 213.

Method 250 continues in step 214, wherein insertion and deletion error characteristics are determined and/or received corresponding to the sleep status data source 101a-101g responsible for providing the sleep time series being converted in method 250. According to particular embodiments, insertion and deletion characteristics are determined in step 214, using the measurement error information received either in optional step 206 or in optional step 213. According to other embodiments, insertion and deletion characteristics are received in step 214. Step-214 received or determined insertion and deletion error characteristics comprise any characteristics capable of expressing the degree to which the corresponding sleep status indication source may or may not properly report the inclusion or exclusion of a sleep interval (see, e.g., Table 2, above). According to particular embodiments, the step-214 determined or received insertion and deletion error characteristics may be expressed as a pair of constants, α and β, which express the false positive rates and the false negative rates, respectively, of the sleep status indication source. To illustrate, if a sleep data source z were error free, there would be an exact correspondence between it and the actual sleep status x. All experimental measurements include some error, however, which can be modeled in a step-202 data fusion method in a probabilistic way. To model deletion and insertion errors (see, e.g., Table 2, above) from a data source, one commonly used notation in statistical error reporting starts by defining two independent error characteristics α and β, where error characteristic α represents false positive errors that occur when the data source reports that the subject is sleeping while in fact the subject is awake, and where error characteristic β represents false negative errors that occur when the data source reports that the subject is awake while in fact the subject is sleeping. That is:

α≡P(awake|report sleeping) (2a)

β≡P(sleeping|report awake) (2b)

Note that these error characteristics α, β are physically meaningful quantities that directly correspond to insertion and deletion errors and which are expressed in probabilistic terms. According to particular embodiments, a given sleep status indication source will have known insertion and deletion error characteristics α, β that will not need to be determined or received uniquely in every iteration of step 214. By way of non-limiting example, a specific brand and/or model of actigraph device will be amenable to determining insertion and/or deletion error characteristics as fixed quantities and may be stored in memory for reuse once known. In such cases, it may not be necessary to receive such error characteristics for that brand and/or model of actigraph every time step 214 is executed.

Method 250 proceeds with step 215, wherein sleep timing error characteristics are determined or received for the sleep source responsible for the sleep time series under conversion in method 250. As with step 214, step 215 may comprise either determining the sleep timing error characteristics from measurement error data received in either step 206 or step 213, according to particular embodiments, or step 215 may comprise receiving the sleep timing error characteristics separately. Sleep timing error characteristics comprise any characteristic capable of reporting the degree to which a sleep data source accurately reports a sleep-to-wake or a wake-to-sleep transition time. As discussed previously, the actual transition time is not always what gets reported. According to particular embodiments, the magnitude δt of timing errors (i.e., how long before or after the actual transition time is the measured transition time reported to be) may be modeled by normal (i.e., Gaussian) distributions N with a zero mean and a constant standard deviation σ, as follows:

P(δt_{w})≡N(0,Γ_{w}) (3a)

P(δtₛ)≡N(0,σₛ) (3b)

where δt_{w} represents the difference between an actual wake time and the corresponding wake time as reported by the data source (i.e., δt_{w}=t_{actual wake}−t_{report wake}), and where δtₛ represents the difference between an actual sleep onset time and the corresponding sleep onset time as reported by the data source (i.e., δtₛ=t_{actual sleep}−t_{report sleep}). That is, the difference between the actual sleep and wake transition times and the recorded diary and/or actigraphy sleep and wake transition times are assumed to be normally distributed across large numbers of measurements, with the standard deviation of this distribution given by the characteristics σ_{w} and σₛ. In this case, values for σ_{w}, σₛ uniquely determine the sleep timing error characteristics, which can be represented by these two characteristics (σ_{w} and σₛ) with no additional information needed (other than the assumption of normal distribution of such errors). Other embodiments (not illustrated) may define sleep timing error characteristics according to other distribution functions and use different statistical parameters for specifying error characteristics. Step-215 received timing error characteristics may also be included as part of optional step-204 received measurement error information, according to particular (non-limiting) embodiments.

For steps 214 and 215, each distinct source of sleep data (i.e., actigraphy, sleep diary, or scheduled sleep) has a unique set of deletion, insertion, and timing error characteristics associated with it, which are modeled according to particular embodiments through a corresponding set of probabilistic error characteristics α, β, σ_{w}, σₛ. Sleep data sources that are highly reliable and/or highly accurate will have small values of α, β, σ_{w}, σₛ, whereas sources that are not reliable and/or not accurate will have larger values. Steps 214 and 215 can be performed in any order. According to particular embodiments (not shown), they may be performed (in whole or in part) for each data source before proceeding with the remaining steps of method 250. For simplicity, the following discussion will assume that steps 214 through 218 are performed in sequence for each data source individually within the plurality 101a-101g of data sources from which sleep data are received in step 201 of method 200. The steps are then repeated until all reporting data sources are exhausted. This simplifying assumption is illustrated in FIG. 2B, in step 206 with reference to repeating steps 201 through 205 for all data sources as needed. The presently disclosed invention, however, is not limited either to this assumption or to a strictly imposed order of processing steps found in method 250 as illustrated in FIG. 2B. As will be demonstrated below, these probabilistic error characteristics (as α, β, σ_{w}, σₛ are called in the aggregate for particular embodiments) has been shown to do a reasonably good job at capturing the deletion, insertion, and timing errors present in real sleep data.

Derivation of the Likelihood Functions of Sleep and Wake for a Single Data Source

Given the above models of deletion, insertion, and timing errors, discussion proceeds next to derive the likelihood functions for sleep and wake, assuming a real data source with non-zero error characteristics α, β, σ_{w}, σₛ. That is, expressions for P(reported sleep|actual sleep) and P(reported wake|actual wake), which account for such errors, are derived and will then be used in the Bayesian data fusion algorithm. It is easiest to model the likelihood functions first assuming only deletion and insertion errors. The corresponding likelihood functions of sleep and wake will be denoted Pₛ and P_{w} in the present discussion when only the insertion and deletion errors have been accounted for. Timing errors can then be modeled separately. The corresponding likelihood functions of sleep and wake will then be denoted [symbol] (sleep) and L(wake)—or, equivalently, [symbol] ₛₗₑₑₚ (t) and [symbol] _{wake} (t), when their time dependence needs to be emphasized—once the timing errors have also been accounted for (in addition to the insertion and deletion errors). Once Bayes' Theorem is applied to the likelihood functions for all data sources, the multisource probabilistic sleep estimate that results (as determined in step 208 of method 200 and/or step 257 of method 250) will be denoted P_{M}(sleep) and/or P_{M}(wake) to indicate the overall probability of sleep and wake, respectively. (Note that there is no contradiction or confusion in referring to P_{M}(wake) as a multisource probabilistic sleep estimate, since it does convey the probability of a sleep state, and, in fact, is equivalent to 1−P_{M}/(sleep)). In what follows, the following additional defining conventions are used:

1=sleeping (4a)

0=awake (4b)

s=actual sleep state (4c)

z=reported sleep state (4d)

So, for example, α and β can be rewritten from Equations 2(a) and 2(b) as:

α=P(s=0|z=1) (5a)

β=P(s=1|z=0) (5b)

Then, starting with the identity:

P(s=1|z=0)P(z=0)+P(s=1|z=1)P(z=1)=P(s=1) (6)

and solving for P(z=0) and P(z=1), respectively, gives:

$$\begin{matrix}P ( z = 0 ) = \frac{P ( s = 1 ) - 1 + α}{β - 1 + α} & ( 7 a ) \\ P ( z = 1 ) = \frac{β - P ( s = 1 )}{β - 1 + α} & ( 7 b )\end{matrix}$$

where the facts that P(z=1)=1−P(z=0), P(s=1)=1−P(s=0),1−a=P(s=1|z=1), and 1−β=P(s=01|z=0) have been utilized. Then, starting with the identities:

$$\begin{matrix}P ( z = 1 \text{\textbar} s = 1 ) = \frac{P ( s = 1 \text{\textbar} z = 1 ) P ( z = 1 )}{P ( s = 1 )} & ( 8 a ) \\ P ( z = 0 \text{\textbar} s = 0 ) = \frac{P ( s = 0 \text{\textbar} z = 0 ) P ( z = 0 )}{P ( s = 0 )} & ( 8 b )\end{matrix}$$

and substituting in from Equations 6, 7a, 7b, 8a, and 8b gives:

$$\begin{matrix}P ( z = 1 \text{\textbar} s = 1 ) = \frac{( 1 - α ) ( β - P ( s = 1 ) )}{P ( s = 1 ) ( β - 1 + α )} & ( 9 a ) \\ P ( z = 0 \text{\textbar} s = 0 ) = \frac{( 1 - β ) ( P ( s = 1 ) - 1 + α )}{( 1 - P ( s = 1 ) ) ( β - 1 + α )} & ( 9 b )\end{matrix}$$

which are the likelihood functions of sleeping and waking, respectively, when only deletion and insertion errors have been accounted for. In accordance with the foregoing notational scheme, these likelihoods as are best labeled as:

Pₛ≡P(z=1|s=1) (10a)

P_{w}≡P(z=0|s=0) (10b)

So therefore, for a particular data source with known α and β:

$$\begin{matrix}{P}_{s} = \frac{( 1 - α ) ( β - P ( s = 1 ) )}{P ( s = 1 ) ( β - 1 + α )} & ( 11 a ) \\ {P}_{w} = \frac{( 1 - β ) ( P ( s = 1 ) - 1 + α )}{( 1 - P ( s = 1 ) ) ( β - 1 + α )} & ( 11 b )\end{matrix}$$

Note that P(s=1) is a constant parameter which represents the probability of the individual actually being asleep at any given time and is also assumed to be known a priori. In light of this derivation, method 250 proceeds with step 216 wherein values for Pₛ and P_{w} are determined in accordance with Equations 11a and 11b, respectively, using the insertion and deletion error characteristics α, β received in step 214 and in accordance with the foregoing discussion.

In light of this derivation, method 250 proceeds with step 216 wherein values for Pₛ and P_{w} are determined in accordance with Equations 11a and 11b, respectively, using the insertion and deletion error characteristics α, β received in step 214 and in accordance with the foregoing discussion.

Regarding the timing errors, a single reported data source can be represented as a sum of sleep intervals {(tₛ, t_{w})}, where tₛ is a reported time that the individual begins sleeping and t_{w} is a reported time that the individual wakes up. Hence, in step 217, the sleep data set(s) received in step 201 from the data source under consideration can be written as a function of time, z(t), as follows:

$$\begin{matrix}z ( t ) = {\sum }_{j} {z}_{j} ( t ; {t}_{s , j} , {t}_{w , j} ) \\ where & ( 12 ) \\ {z}_{j} ( t ; {t}_{s , j} , {t}_{w , j} ) = \{ \begin{matrix}1 , & {t}_{s , j} \leq t < {t}_{w , j} , \\ 0 , & otherwise .\end{matrix} & ( 13 )\end{matrix}$$

recalling the (non-limiting) convention that “1” represents a reported sleep state and that “0” represents a reported wake state, and using j as the index variable to identify each sleep interval within the sleep data as reported by a given data source. According to particular embodiments, the step-201 received sleep data may already be in this form for one or more of the sleep data sources 101a-101g, and hence step 217 may not always be necessary. When there are no timing errors in the data source, the sleep and wake likelihoods reduce to those derived above, that is:

P(z(t)=1|s(t)=1)=Pₛ (14a)

P(z(t)=0|s(t)=1)=1−Pₛ (14b)

P(z(t)=0|s(t)=0)=P_{w} (14c)

P(z(t)=1|s(t)=0)=1−P_{w} (14d)

or equivalently:

P(z(t)|s(t)=1)=(2Pₛ−1)z(t)+1−Pₛ (15a)

P(z(t)|s(t)=0)=(1−2P_{w})z(t)+P_{w} (15b)

Therefore the likelihood of sleep and the likelihood of wake, when considering only the insertion and deletion errors, may then be written:

$$\begin{matrix}P ( z ( t ) \vert s ( t ) = 1 ) = {\sum }_{j} ( ( 2 {P}_{s} - 1 ) {z}_{j} ( t ; {t}_{sj} , {t}_{wj} ) + 1 - {P}_{s} ) & ( 16 a ) \\ P ( z ( t ) \vert s ( t ) = 0 ) = {\sum }_{j} ( ( 1 - 2 {P}_{w} ) {z}_{j} ( t ; {t}_{sj} , {t}_{wj} ) + {P}_{w} ) & ( 16 b )\end{matrix}$$

To include the timing errors, the expected values of the likelihoods given the assumed distribution of timing errors must be found. These are calculated, in step 218 of method 250, by integrating over all possible timing errors for each sleep-wake transition independently, as follows:

$$\begin{matrix}{ℒ}_{sleep} ( t ) = {\sum }_{j} \int \int ( ( 2 {P}_{s} - 1 ) {z}_{j} ( t ; {t}_{sj} + {x}_{j} , {t}_{wj} + {y}_{j} ) + 1 - {P}_{s} ) N ( {x}_{j} ; 0 , {σ}_{w} ) N ( {y}_{j} ; 0 , {σ}_{s} ) d {x}_{j} d {y}_{j} & ( 17 a ) \\ {ℒ}_{wake} ( t ) = {\sum }_{j} \int \int ( ( 1 - 2 {P}_{w} ) {z}_{j} ( t ; {t}_{sj} + {x}_{j} , {t}_{wj} + {y}_{j} ) + {P}_{w} ) N ( {x}_{j} ; 0 , {σ}_{w} ) N ( {y}_{j} ; 0 , {σ}_{s} ) d {x}_{j} d {y}_{j} & ( 17 b )\end{matrix}$$

In the neighborhood of the sleep and wake transition times, the uncertainty in the actual sleep onset and wake times results in a smooth transition probability between wake and sleep states and between sleep and wake states, respectively. Based on the assumed Normal distribution of timing errors, the transition between sleep and wake states follows the Normal cumulative distribution function.

As alluded to above, steps 214 through 218 of method 250 are repeated for each sleep data source providing a sleep data set in step 201 of method 200 until all such data sources are addressed. This looping function is indicated by step 219 in FIG. 2B.

Conversion of Sleep Interval Data to a Sleep Time Series

Turning now to FIG. 2C, a flowchart diagram is provided in which is illustrated method 260, a non-limiting exemplary method for converting sleep interval data into a sleep time series, in satisfaction of step 245 of method 200 (specifically data conversion sub-process 235) of FIG. 2A. Method 260 commences in step 222, wherein one or more sleep intervals and/or one or more wake intervals are extracted from the step-201 received sleep data, in accordance with particular embodiments. Step 222 comprises analyzing the step-201 received sleep data for identified sleep intervals according to methods well understood in the art.

Method 260 then proceeds to step 223, wherein the one or more step-222 extracted sleep periods and/or the one or more step-222 extracted wake periods are converted into sleep time series, in accordance with particular embodiments. Step 223 comprises combining the set of sleep start and end times {tₛ} and {t_{w}} into a sleep time series based on the mathematical formulas:

$$\begin{matrix}STS ( t ) = {\sum }_{j} {I}_{j} ( t ; {t}_{s , j} , {t}_{w , j} ) \\ where & ( 23 ) \\ {I}_{j} ( t ; {t}_{s , j} , {t}_{w , j} ) = \{ \begin{matrix}1 , & {t}_{s , j} \leq t < {t}_{w , j} , \\ 0 , & otherwise .\end{matrix} & ( 24 )\end{matrix}$$

where STS represents the sleep time series, and where I represents the sleep intervals.

Bayesian Fusion of Likelihood Functions of Sleep and Wake after Error Adjustment

FIG. 2D provides a flowchart diagram for a method, comprising a single step 231, to implement a Bayesian data fusion algorithm on one or more sleep state functions, in accordance with particular embodiments. Once the sleep state functions [symbol] (sleep) and [symbol] (wake) have been determined for all data sources accounting for insertion errors, deletion errors, and timing errors, Bayes' Theorem is then used, in step 231, to combine the resulting estimates from multiple data sources into a single multisource sleep estimate which describes the overall probability of sleep given the observed data. Combining the sleep state functions using Bayes rule—and dropping the independent time variable, t, for compactness, and assuming only two sleep data sources z₀, z₁ for simplicity—yields:

$${P}_{M} ( s \text{\textbar} {z}_{0} , {z}_{1} ) = \frac{P ( s , {z}_{0} , {z}_{1} )}{P ( {z}_{0} , {z}_{1} )} \qquad ( 18 )$$

where s represents one of the two sleep states, i.e., either s=sleep or s=wake, in which case Equation 18 lends itself towards finding formulas for P_{M}(sleep) and P_{M}(wake), respectively. While the observed data sources, z₀ and z₁ are in general not independent, they are conditionally independent given the true sleep state. Thus:

$${P}_{M} ( s \text{\textbar} {z}_{0} , {z}_{1} ) = \frac{P ( {z}_{0} , {z}_{1} , s )}{P ( {z}_{0} , {z}_{1} )} = \frac{P ( {z}_{0} , {z}_{1} \text{\textbar} s ) P ( s )}{P ( {z}_{0} , {z}_{1} )} = \frac{P ( {z}_{0} \text{\textbar} s ) P ( {z}_{1} \text{\textbar} s ) P ( s )}{P ( {z}_{0} , {z}_{1} )} \qquad ( 19 )$$

where the denominator P(z₀, z₁) is a normalization term that can be found by integrating the numerator over the sleep and wake states, yielding:

$$\begin{matrix}{P}_{M} ( sleep ) = {P}_{M} ( s = 1 \text{\textbar} {z}_{0} , {z}_{1} ) = \frac{P ( {z}_{0} \text{\textbar} s = 1 ) P ( {z}_{1} \text{\textbar} s = 1 ) P ( s = 1 )}{{\sum }_{i = 0}^{i = 1} P ( {z}_{0} \text{\textbar} s = i ) P ( {z}_{1} \text{\textbar} s = i ) P ( s = i )} & ( 20 a ) \\ {P}_{M} ( wake ) = {P}_{M} ( s = 0 \text{\textbar} {z}_{0} , {z}_{1} ) = \frac{P ( {z}_{0} \text{\textbar} s = 0 ) P ( {z}_{1} \text{\textbar} s = 0 ) P ( s = 0 )}{{\sum }_{i = 0}^{i = 1} P ( {z}_{0} \text{\textbar} s = i ) P ( {z}_{1} \text{\textbar} s = i ) P ( s = i )} & ( 20 b )\end{matrix}$$

The overall effect of the Bayesian data fusion as expressed in Equation 20 is that sources which are highly reliable are weighted more strongly than data sources with low reliability and large timing errors. One of the benefits of using a Bayesian framework is the ease that additional sources can be added and subtracted from Equation 20, yielding:

$${P}_{M} ( s \vert {z}_{0 } … {z}_{n} ) = \frac{P ( s )}{P ( {z}_{0} … {z}_{n} )} \qquad ( 21 )$$

from which P_{M}(sleep) and P_{M}(wake) may be generalized thusly:

$$\begin{matrix}{P}_{M} ( sleep ) = {P}_{M} ( s = 1 \text{\textbar} {z}_{0 } … {z}_{n} ) = \frac{{\prod }_{i = 0}^{i = n} P ( {z}_{i} \text{\textbar} s = 1 ) P ( s = 1 )}{{\sum }_{k = 0}^{k = 1} {\prod }_{i = 0}^{i = n} P ( {z}_{i} \text{\textbar} s = k ) P ( s = k )} & ( 22 a ) \\ {P}_{M} ( wake ) = {P}_{M} ( s = 0 \text{\textbar} {z}_{0} … {z}_{n} ) = \frac{{\prod }_{i = 0}^{i = n} P ( {z}_{i} \text{\textbar} s = 0 ) P ( s = 0 )}{{\sum }_{k = 0}^{k = 1} {\prod }_{i = 0}^{i = n} P ( {z}_{i} \text{\textbar} s = k ) P ( s = k )} & ( 22 b )\end{matrix}$$

where it is understood that P_{M}(sleep)=1−P_{M}(wake).

The consolidated estimate of sleep provided by the multisource probabilistic sleep estimate P_{M}(s|z₀ . . . zₙ) of Equation 21 (or alternatively and equivalently, P_{M}(sleep) and P_{M}(wake) of Equations 22a and 22b, respectively), may be defined by the maximum a posterior (MAP) estimate, and in the case of only two possible states (wake and sleep) is equivalent to finding the time where the probability of sleep given the observed measurements is greater than 0.5. Applications requiring a bias toward one or the other of these states may use a larger or smaller value than 0.5 according to particular embodiments.

Estimating Sleep Status from a Single Data Source with Known Error Characteristics

FIG. 3B provides a graph of a pair of sleep state functions 308, 309 corresponding to the measured sleep status of an individual according to a sleep state indicator of known error characteristics, in accordance with particular embodiments. A 48-hour timeline is provided (X-axis) on which is graphed (Y-axis) both P_{M}(sleep) 308 and P_{M}(wake) 309, in accordance with the values determined by Equations 22a and 22b. These values represent the likelihood functions of sleep and wake, respectively, after insertion errors, deletion errors, and timing errors have been accounted for. Calculated values for P_{w}, Pₛ, 1−P_{w} and 1−Pₛ, which are constants derived from the error characteristics α, β, σₛ, σ_{w} for a given sleep status indication source (see, e.g., Equations 11(a) and 11(b) and surrounding discussion), are shown as asymptotes 304a, 304b, 306a, and 306b, respectively. Whenever the values of P_{M}(sleep) 308 and P_{M}(wake) 309 intersect (at a value of 0.500, since their sum is always 1.000), a new boundary is created representing an estimated transition from sleep to wake or from wake to sleep. Alternative embodiments may bias the sleep interval estimation in one direction or another by utilizing a different value than 0.500 for the cutoff threshold for determining a sleep-wake or wake-sleep transition time.

Using the 0.500 threshold (illustrated), intersection 305a represents the boundary between wake period 301a and sleep period 302a. Intersection 305b represents the boundary between sleep period 302a and wake period 301b. Intersection 305c represents the boundary between wake period 301b and sleep period 302b. Intersection 305d represents the boundary between sleep period 302b and wake period 301c. And intersection 305e represents the boundary between wake period 301c and sleep period 302c.

Worked Examples of Bayesian Sleep Fusion

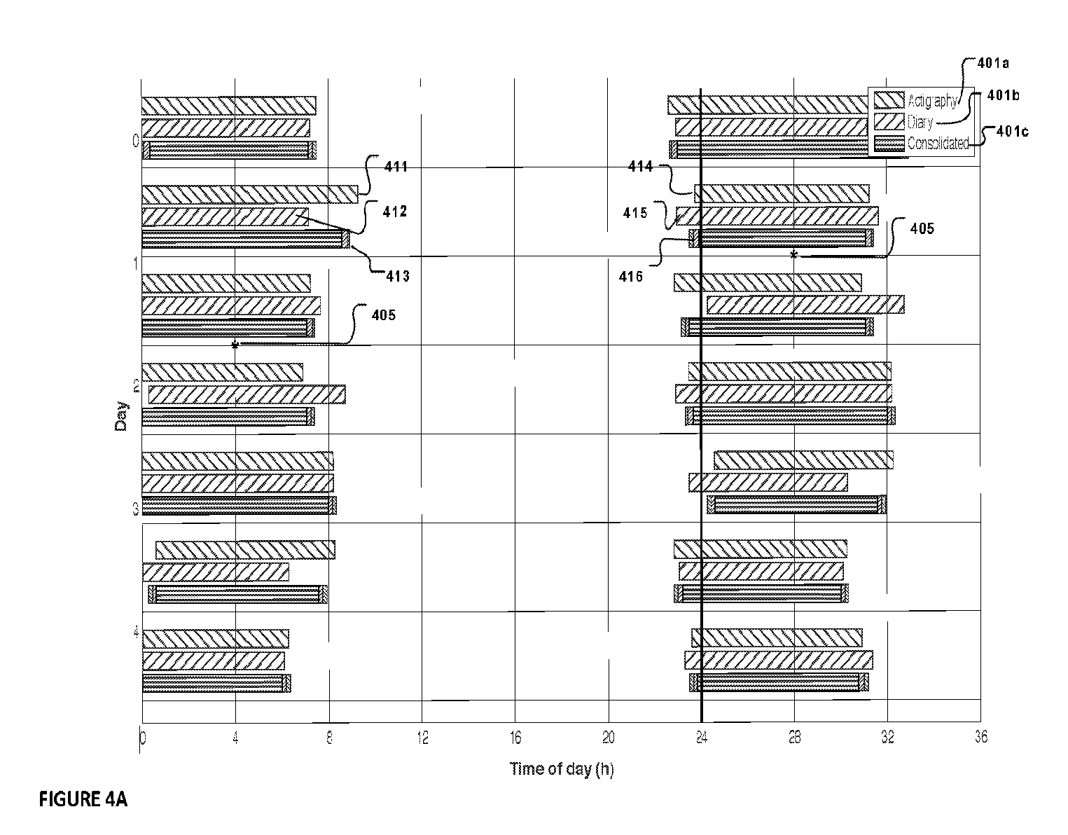

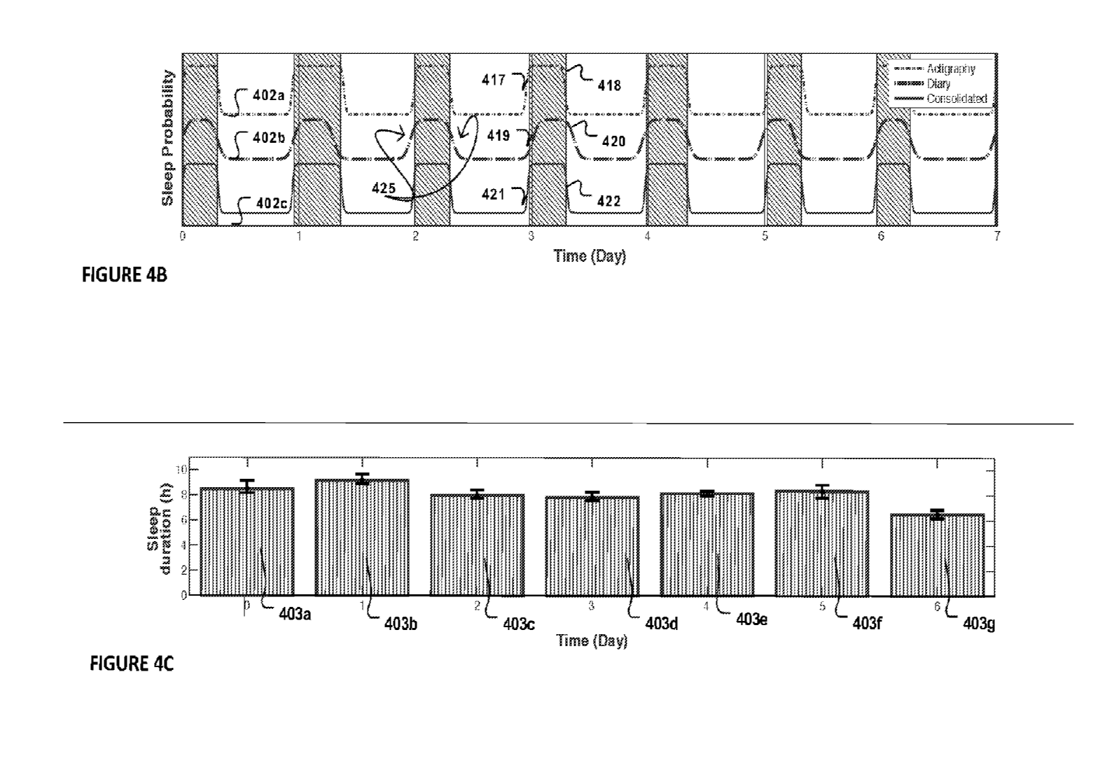

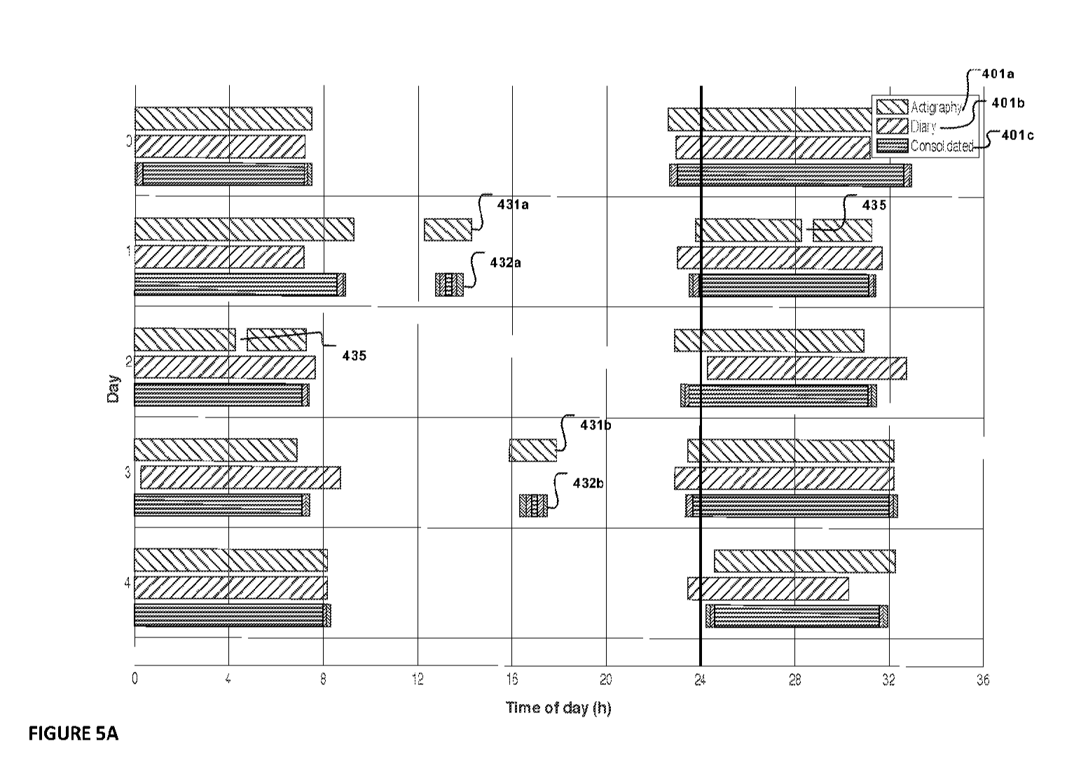

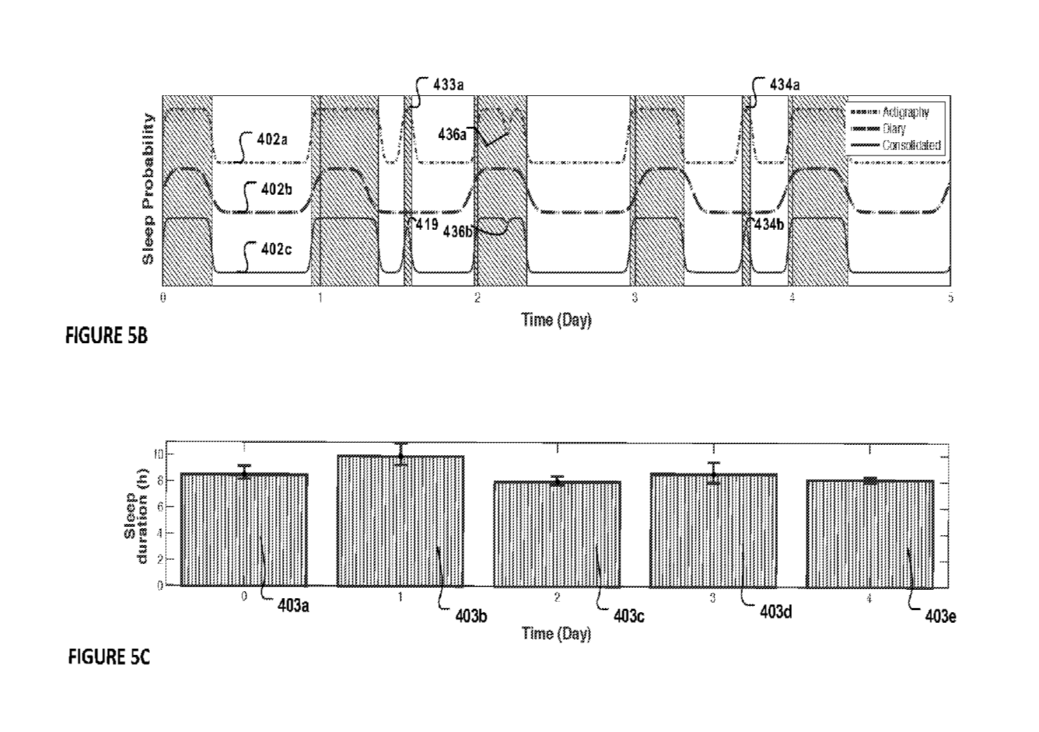

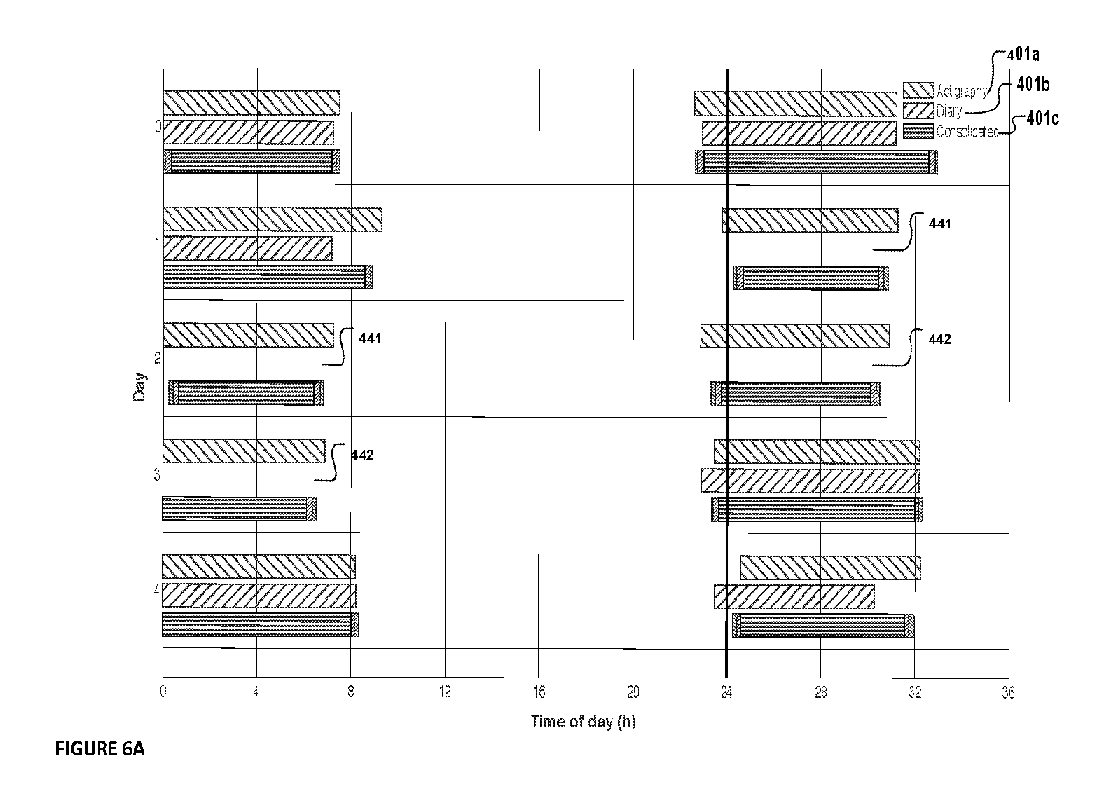

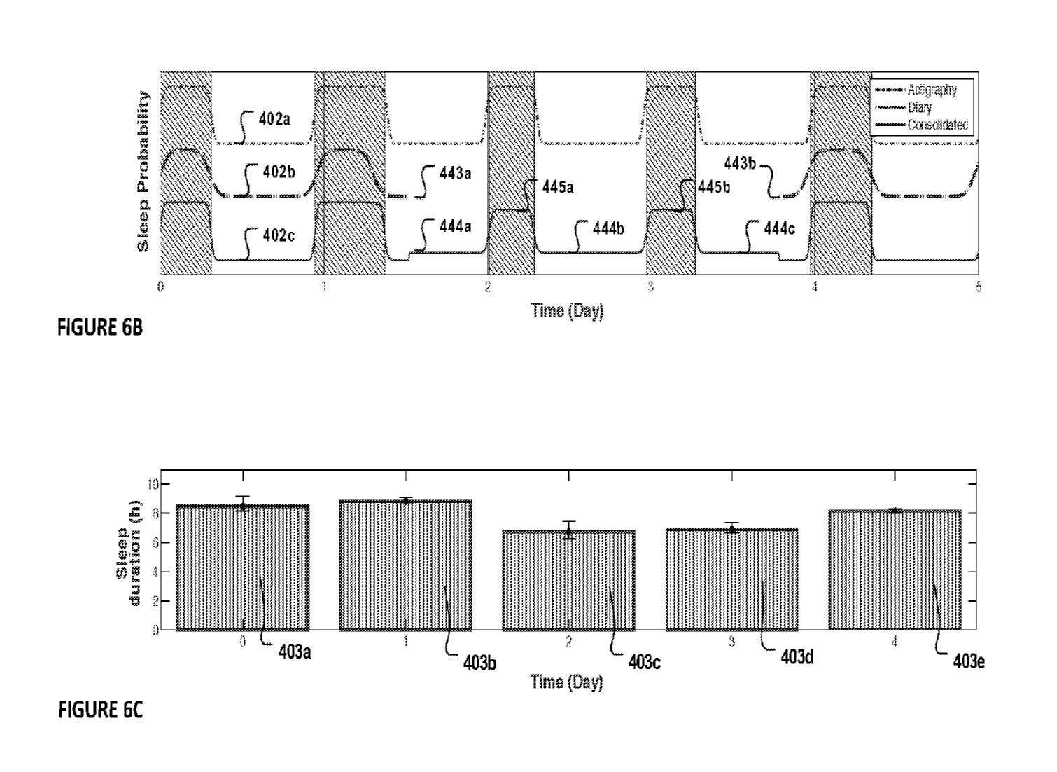

The multiple views of FIGS. 4, 5, and 6 illustrate several worked examples of the step-205 Bayesian data fusion algorithm outlined in method 250 of FIG. 2B and as applied to sample sleep data, in accordance with particular embodiments. In each view, sleep data is collected from multiple sleep status indication sources over a multiple-day period, but one or more data errors (see Table 2) are present. Illustrated specifically is the common (but non-limiting) situation where sleep data is collected from both actigraphy 401a and sleep diary 401b, and combined into the multisource probabilistic sleep estimate 401c (the latter being identified in the multiple views of FIG. 4 as “consolidated”). Timing errors are illustrated in each of FIGS. 4, 5, and 6, but are discussed at length only in connection with FIG. 4; insertion errors are illustrated in FIG. 5 (and discussed therewith); and deletion errors are illustrated in FIG. 6 (and discussed therewith). The reported sleep periods are shown as recorded by actigraphy (top line) 401a and with a sleep diary (middle line) 401b, and a consolidated sleep period (bottom line) 401c (i.e., the sleep period resulting from a Bayesian data fusion technique resulting in a multisource probabilistic sleep estimate) in each chart of FIGS. 4A, 5A, and 6A.

When the set of error characteristic values (Pₛ, P_{w}, σ_{w}, σₛ) for actigraphy readings and for sleep diary entries is provided, a likelihood of sleep function [symbol] (sleep) can be computed using Equation 17a and as shown, in part, in the middle charts, i.e., charts of FIGS. 4B, 5B, and 6B. Likelihood of sleep for the actigraphy alone [symbol] _{act.}(sleep) 402a, and for sleep diary alone [symbol] _{diary.}(sleep) 402b alone are shown as the top and middle lines in each middle chart (i.e., charts of FIGS. 4B, 5B, and 6B). The consolidated sleep estimate of these two sources, i.e., multisource probabilistic sleep estimate P_{M}(sleep), is also illustrated as the bottom line 402c as well. Lastly, the estimated total sleep per day 403a through 403g is shown in each of the bottom charts (i.e., charts of FIGS. 4C, 5C, and 6C) along with corresponding error bars (not labeled).

It must be noted, however, that all of the top charts 400A-1, 400B-1, and 400C-1 illustrate sleep and wake intervals plotted on a 36-hour timeline, not a 24-hour timeline. Such a technique allows for easier visualization of sleep intervals that cross over from one day to another, but it introduces some duplication of data within the visualization. By way of illustration (but without limitation), the 28^{th} hour of day 2, denoted in FIG. 4A with an asterisk * 405, is the same time as the 4^{th} hour of day three (also denoted in FIG. 4A with an asterisk * 405). The 24^{th} hour of each time period is highlighted in each graph as a reminder.

With regard to FIG. 4A, the method 200 is applied to sleep data containing sleep timing errors, according to particular embodiments. Notably the actigraphy readings 401a do not reflect the same sleep-to-wake transition times 411 or the same wake-to-sleep transition times 414 as do the sleep diary data entries 401b for the same transitions 412, 415, respectively. Timing error characteristics for sleep diary entries are presumed to be fairly large (i.e., fairly large values of σₛ are used). Hence, the timing uncertainty in sleep diary data 401b is assumed to be relatively large, which results in a relatively large roll-off estimated sleep probability in transition regions 425 and at other similar sleep and wake transitions (not labeled) in FIG. 4B. As can be seen in FIG. 4B, when the sleep periods coincide, the overall confidence that sleep is actually occurring is higher than for each of the individual estimates of sleep.

Using the reported sleep times for the second day (i.e., Day No. 1, with numbering commencing at 0) as an example, the sleep-to-wake transition time 411 as recorded by actigraphy differs from the sleep-to-wake transition time 412 as recorded by a sleep diary. Similar differences can be seen for the wake-to-sleep transition times 414, 415 recorded by actigraphy and sleep diary, respectively, for later in Day No. 1, as illustrated in FIG. 4A. Using this sleep data, FIG. 4B shows the respective likelihoods of sleep [symbol] _{act.}(sleep) and [symbol] _{diary}(sleep) during the corresponding transition periods. Transition regions 417 and 418 illustrate the estimated likelihood of sleep during the wake-to-sleep transition and sleep-to-wake transitions, respectively, of Day 1 as recorded by actigraphy. Similarly, transition regions 419 and 420 illustrate the sleep likelihood for the same transitions, but using data collected from a sleep diary. Notably, the sleep likelihood curve is less steep for the sleep diary than for actigraphy, as illustrated in the respective slopes of transition regions 417 and 418 as compared to 419 and 420 because of different values of error characteristics α, β, σ_{w}, σₛ (see Equations 2a, 2b, 3a, 3b). Likewise, when a wake event is recorded by both sources, the overall confidence of sleep is lower than the individual estimates of sleep as in 421 and 422. When sleep estimates are in conflict (sleep reported by one source, and wake reported by another source, or vice versa), the overall confidence is somewhere between the two estimates.

FIG. 5 illustrates a step-203 determined multisource probabilistic sleep estimate according to method 200 (FIG. 2A) applied to sleep data where additional sleep periods are recorded by one source but not another, so-called “insertion errors” (see Table 2), in accordance with particular embodiments. Actigraphy data 401a (top line) introduces extraneous sleep intervals 431a, 431b (in Days 1 and 3, respectively) and introduces a brief wake period 435 (in Day 2) during sleep, none of which are recorded by the sleep diary data 401b (middle line). This is likely due to periods of low activity while awake (e.g., periods 431a, 431b) and a period of restlessness while asleep (i.e., period 435). The step-203 determined multisource probabilistic sleep estimate 401 is the result of the fusion of actigraphy data 401a and the sleep diary data 401b. The multisource probabilistic sleep estimate 401 is also graphed in FIG. 5B as line 402c. Because there is conflict between sleep diary data and actigraphy on Day Nos. 1 and 3, at the aforementioned times, the confidence that sleep actually occurred at the those times is relatively low, as is indicated by the step-206 determined multisource probabilistic sleep estimate 401c at the corresponding times 432a and 432b of FIG. 5A and at the corresponding times 433b and 434a of FIG. 5B, respectively. The sleep awakening recorded during the night by the actigraphy at 436a but not the sleep diary results in the overall estimate to be scored as sleep at 436b, albeit with a lower overall confidence that sleep occurred at that time.

Further, the multiple views of FIG. 6 illustrate the step-203 determined multisource probabilistic sleep estimate determined according to method 200 (FIG. 2A) applied to sleep data containing missing sleep entries (i.e., deletion errors, see Table 2), in accordance with particular embodiments. This example illustrates the case where the sleep diary is missing entries for Day Nos. 2 and 3 (and part of Day No. 1 as indicated at 441 and 442), which is likely the result of the subject failing to make entries into the sleep diary, not that the subject endured a 58-hour continuous sustained wake period (although the Bayesian model permits for a slight probability that the latter scenario is accurate). According to particular embodiments, the data fusion method may encompass the application of various heuristic rules (see, e.g., step 212 of method 250) that look for extended periods of wakefulness or sleep with durations that exceed a preset threshold (e.g. 16 to 20 hours). (See Table 3). These periods are marked as unreliable according to particular embodiments. Particular embodiments of the Bayesian data fusion method may ignore unreliable sources in the estimation of sleep and only utilize the reliable sources (actigraphy). Particular embodiments may also insert a likely sleep episode according to other step-212 applied heuristic rules. For the present example, however, a heuristic rule is applied that marks the missing period as unreliable and is indicated by no value of the likelihood of sleep function due to sleep diary alone 402b between the time periods 443a and 443b, where no value for the function is given. The overall sleep likelihood value is also lower during the sleeping periods of days 2 and 3, since only one data source is available (as opposed to two sources in agreement in the other days), as illustrated by regions 445a and 445b of the multisource probabilistic sleep estimate 402c of FIG. 6B. Based on the low likelihood of the event, the heuristic method scores the period of extended wakefulness as unreliable data, and the data fusion bases its assessment only on the remaining sleep source.

Applications of the presently disclosed systems, methods, and non-transitory computer-memory products comprise the estimation of sleep and/or fatigue within a wide variety of operational settings, including (without limitation) military operations, industrial settings, space flight operations, including extra-vehicular activities (i.e., manned activities conducted outside a flight vehicle in space), aviation, transportation, sleep research, medical and/or academic research involving sleep and/or fatigue, healthcare, fatigue and/or sleep educational settings, and/or the like.

Certain implementations of the invention comprise computer processors which execute software instructions which cause the processors to perform a method of the invention. One or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

As will be apparent to those skilled in the art in light of the foregoing disclosure, many alterations and modifications are possible in the practice of this invention without departing from the spirit or scope thereof.

While several exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as within their true spirit and scope.

What is claimed is:

1. A method, using a computer, for determining a multisource probabilistic sleep estimate for an individual, the method comprising:
receiving, at a computer, a plurality of sleep state functions for an individual within a time interval of interest, each sleep state function representing a likelihood of the individual being in a particular sleep-wake state at one or more times within the time interval of interest; and
determining, with the computer, a multisource probabilistic sleep estimate for the individual by applying a data fusion algorithm to the received plurality of sleep state functions, wherein the data fusion algorithm comprises a combining operation operating on each of the sleep state functions.

2. A method according to claim 1 wherein, for at least one of the plurality of received sleep state functions, receiving the sleep state function comprises:
receiving, at the computer, a sleep time series from a sleep status indication source, the sleep time series representing a sleep-wake status of the individual within the time interval of interest as a categorical time series comprising at least a first and second category, wherein the first category represents a sleep state for the individual for specified periods, and wherein the second category represents a wake state for the individual for specified periods; and
converting, with the computer, the received sleep time series into a sleep state function by modifying the received sleep time series by one or more error characteristics representing measurement uncertainty associated with the sleep status indication source from which the sleep time series was received.

3. A method according to claim 2 wherein, for at least one of the plurality of received sleep state functions, receiving the sleep state function comprises:
receiving, at the computer, sleep data from a sleep status indication source, the sleep data comprising any data, other than a sleep state function or a sleep time series, that indicates a sleep-wake status of the individual within the time interval of interest;
extracting from the received sleep data one or more sleep periods and one or more wake periods, each sleep period comprising a sleep onset time representing when the individual goes to sleep, a sleep end time representing when the individual wakes up, and a sleep duration representing a duration between the sleep onset time and the sleep end time, and each wake period comprising a wake-onset time representing when the individual wakes up, a wake end time representing when the individual goes to sleep, and a wake period comprising a duration between the wake onset time and the wake end time; and
converting the one or more extracted sleep periods and the one or more extracted wake periods into a sleep time series representing a sleep-wake status of the individual within the time interval of interest as a categorical time series comprising at least a first and second category, wherein the first category represents a sleep state for the individual for specified periods comprising the extracted sleep periods, and wherein the second category represents a wake state for the individual for specified periods comprising the extracted wake periods.

4. A method according to claim 1 wherein the combining operation comprises a Bayesian statistical data fusion algorithm.

5. A method according to claim 1 wherein at least one of the plurality of sleep status indication sources comprises: an actigraphy device, a sleep diary, a sleep schedule, a sleep history, a work schedule, a work history, a polysomnigraph, observation of the individual sleeping, and a self-report of sleep accompanying a neurocognitive test.

6. A method according to claim 1 wherein the time interval of interest corresponds to one or more of: a work interval, a military operation, a space flight mission, an extra-vehicular activity during space flight, an observation period for medical or scientific research, and a critical fatigue period.

7. A method according to claim 2 wherein the received sleep time series comprises a binary sleep function, wherein the binary sleep function assigns a first and a second value to the sleep-wake status of the individual at one or more times, wherein the first value corresponds to the first category of the categorical time series comprising the received sleep time series, and wherein the second value corresponds to the second category of the categorical time series comprising the received sleep time series.

8. A method according to claim 7, wherein the first and second values are non-identical members of a continuous mathematical space capable of indicating intermediate values between the first and second values, and wherein the intermediate values correspond to probabilities that the individual may be asleep or may be awake at a given time when the individual's actual sleep-wake status is uncertain or not fully known.

9. A method according to claim 8 wherein the intermediate values comprise the decimal or factional numbers between 0 and 1, and either wherein the first value comprises 0 and the second value comprises 1, or wherein the first value comprises 1 and the second value comprises 0.

10. A method according to claim 1 wherein at least one of the plurality of received sleep state functions comprises a function of a discrete time variable.

11. A method according to claim 1 further comprising:
modifying, with the computer, at least one of the plurality of received sleep state functions using one or more heuristic rules, the modified sleep state functions being representative of a correction to the measured sleep-wake status of an individual over time as determined by the corresponding sleep status indication source, the heuristic rules representing techniques for correcting sleep data to account for common errors in sleep data collection from the corresponding sleep status indication source.

12. A method according to claim 3 further comprising:
modifying, with the computer, the received sleep data by applying one or more heuristic rules to the received sleep data, the modified sleep data being representative of a correction to the measured sleep-wake status of an individual over time as determined by the corresponding sleep status indication source to account for common errors in sleep data collection, the heuristic rules representing techniques for correcting sleep data to account for common errors in sleep data collection from the corresponding sleep status indication source.

13. A method according to claim 11 wherein the one or more heuristic rules comprise one or more of: inserting likely sleep intervals, deleting false naps, smoothing discontinuous sleep, replicating recent sleep history, inferring sleep history from work history, and predicting future sleep from future work schedule data.

14. A method according to claim 12 wherein the one or more heuristic rules comprise one or more of: inserting likely sleep intervals, deleting false naps, smoothing discontinuous sleep, replicating recent sleep history, inferring sleep history from work history, and predicting future sleep from future work schedule data.

15. A method according to claim 2 further comprising:
receiving, at the computer, measurement error information for at least one of the plurality of sleep status indication sources, the received measurement error information representing measurement uncertainty associated with the sleep status indication source.

16. A method according to claim 15 wherein the received measurement error information comprises the one or more error characteristics used to modify the received sleep time series.

17. A method according to claim 15 wherein the received measurement error information comprises at least in part a probability of error between an actual sleep-wake status at a given time and a reported sleep-wake status as indicated by the corresponding sleep status indication source for the given time.

18. A method according to claim 15 wherein the received error information comprises at least in part a pair of insertion-deletion error characteristics, α and β, for at least one sleep status indication source i, such that:
αᵢ≡P(s=wake|rᵢ=sleep),
and
β≡P(s=sleep|rᵢ=wake)
wherein αᵢ denotes the probability that the corresponding i^{th} one of the plurality of sleep status indication sources falsely reports that the individual is sleeping when the individual is actually awake,
wherein βᵢ denotes the probability that the corresponding i^{th} one of the plurality of sleep status indication sources falsely reports that the individual is awake when the individual is actually asleep,
wherein s is the actual sleep-wake status of the individual, expressed as either a wake state (“wake”) or a sleep state (“sleep”), and
wherein rᵢ is the reported sleep-wake status of the individual as indicated by the corresponding i^{th} one of the plurality of sleep status indication sources, expressed as either a wake state or a sleep state.

19. The method of claim 18 wherein determining, with the computer, a multisource probabilistic sleep estimate for the individual by applying a data fusion algorithm to the received plurality of sleep state functions comprises at least in part determining a likelihood of sleep function Pₛ and a likelihood of wake function P_{w}, for at least one of the sleep measurement data sources, of the following forms:
$${P}_{s , i} = \frac{( 1 - {α}_{i} ) ( {β}_{i} - P ( s = 1 ) )}{P ( s = 1 ) ( {β}_{i} - 1 + {α}_{i} )} , \\ and$$
$${P}_{w , i} = \frac{( 1 - {β}_{i} ) ( P ( s = 1 ) - 1 + {α}_{i} )}{( 1 - P ( s = 1 ) ) ( {β}_{i} - 1 + {α}_{i} )}$$
wherein likelihood of sleep functions P_{s,i} and likelihood of wake functions P_{w,i} represent the probability that the i^{th} one of the plurality of sleep status indication sources is properly reporting sleep state and wake state, respectively, after accounting for insertion errors and deletion errors; and
wherein P(s=1) comprises a constant parameter representing the probability of the individual being asleep at any given time.

20. The method of claim 15 wherein the received measurement error information comprises at least in part a statistical distribution corresponding to at least one of the plurality of sleep status indication sources, wherein the statistical distribution represents a probable difference between actual sleep-wake transition times and reported sleep-wake transition times as indicated by the corresponding sleep status indication source.

21. The method of claim 20 wherein the statistical distribution comprises a normal distribution.

22. The method of claim 21 wherein the received measurement error information comprises at least in part one or more values for error characteristics σₛ, and σ_{w}, for the at least one sleep status indication source, as defined implicitly when the normal distributions take the following forms:
P(δt_{s,i})=N(0,σ_{s,i}),
and
P(δt_{w,i})=N(0,δ_{w,i})
wherein δt_{s,i} represents a difference between an actual sleep onset time and a reported sleep onset time as indicated by the i^{th} sleep status indication source (i.e., δt_{s,i}=t_{actual sleep}−t_{reported sleep,i});
wherein δt_{w,i} represents a difference between an actual wake time and a reported wake time as indicated by the i^{th} sleep status indication source (i.e., δt_{w,i}=t_{actual wake}−t_{reported wake,i});
wherein P(δt_{s,i}) and P(δt_{w,i}) represent the probabilities of error associated with the i^{th} sleep status indication source accurately reporting a wake-to-sleep transition time and a sleep-to-wake transition time, respectively;
wherein σ_{s,i} and σ_{w,i} represent standard deviations of transition-time reporting errors for the i^{th} sleep status indication source with regard to wake-to-sleep transition times and sleep-to-wake transition times, respectively; and
wherein N represents a normal distribution.

23. The method of claim 1 further comprising:
representing, using the computer, at least one of the received plurality of sleep functions as a sum of sleep intervals for the at least one corresponding sleep status indication source, a sleep interval representative of a time period the individual is sleeping, wherein the sum of sleep intervals for the at least one corresponding sleep status indication source may be represented as:
$${z}_{i} ( t ) = {\sum }_{j} {z}_{j} ( t ; {t}_{s , j} , {t}_{w , j} )$$
$$where$$
$${z}_{j} ( t ; {t}_{s , j} , {t}_{w , j} ) = \{ \begin{matrix}1 , & {t}_{s , j} \leq t < {t}_{w , j} , \\ 0 , & otherwise .\end{matrix}$$
wherein zᵢ(t) represents the individual's reported sleep state as a function of time for the corresponding i^{th} one of the plurality of sleep status indication sources;
wherein j comprises an index variable for each sleep interval reported within a sleep data set,
wherein t_{s,j} and t_{w,j} represent one or more wake-to-sleep transition times and one or sleep-to-wake transition times, respectively, as reported by the sleep status indication source;
wherein the sleep state is represented by “1” and wherein the wake state is represented by “0”; and
wherein t represents an independent time variable.

24. A method according to claim 19 further comprising:
representing, using the computer, at least one of the received plurality of sleep functions as a sum of sleep intervals for the at least one corresponding sleep status indication source, a sleep interval representative of a time period the individual is sleeping, wherein the sum of sleep intervals for the at least one corresponding sleep status indication source may be represented as:
$${z}_{i} ( t ) = {\sum }_{j} {z}_{j} ( t ; {t}_{s , j} , {t}_{w , j} )$$
$$where$$
$${z}_{j} ( t ; {t}_{s , j} , {t}_{w , j} ) = \{ \begin{matrix}1 , & {t}_{s , j} \leq t < {t}_{w , j} , \\ 0 , & otherwise .\end{matrix}$$
wherein zᵢ(t) represents the individual's reported sleep state as a function of time for the corresponding i^{th} one of the plurality of sleep status indication sources;
wherein j comprises an index variable for each sleep interval reported within a sleep data set,
wherein t_{s,j} and t_{w,j} represent one or more wake-to-sleep transition times and one or sleep-to-wake transition times, respectively, as reported by the sleep status indication source;
wherein the sleep state is represented by “1” and wherein the wake state is represented by “0”; and
wherein t represents an independent time variable;
wherein the received measurement error information further comprises at least in part one or more values for error characteristics σₛ, and σ_{w}, for the at least one sleep status indication source, as defined implicitly when the normal distributions take the following forms:
P(δt_{s,i})=N(0,σ_{s,i}),
and
P(δt_{w,i})=N(0,σ_{w,i})
wherein δt_{s,i} represents a difference between an actual sleep onset time and a reported sleep onset time as indicated by the i^{th} sleep status indication source (i.e., δt_{s,i}=t_{actual sleep}−t_{reported sleep,i});
wherein δt_{w,i} represents a difference between an actual wake time and a reported wake time as indicated by the i^{th} sleep status indication source (i.e., δt_{w,i}=t_{actual wake}−t_{reported wake,i});
wherein P(δt_{s,i}) and P(δt_{w,i}) represent the probabilities of error associated with the i^{th} sleep status indication source accurately reporting a wake-to-sleep transition time and a sleep-to-wake transition time, respectively;
wherein σ_{s,i} and σ_{w,i} represent standard deviations of transition-time reporting errors for the i^{th} sleep status indication source with regard to wake-to-sleep transition times and sleep-to-wake transition times, respectively;
wherein N represents the normal distribution; and
wherein determining, with the computer, a multisource probabilistic sleep estimate for the individual by applying a data fusion algorithm to at least in part the received plurality of sleep functions further comprises at least in part determining a likelihood of sleep function [symbol] (sleep) and a likelihood of wake function [symbol] (wake) for at least one of the sleep status indication sources, of the following forms:
$${ℒ}_{i} ( sleep ) = {\sum }_{j} \int \int ( ( 2 {P}_{s , i} - 1 ) {z}_{j} ( t ; {t}_{s , j} + {x}_{j} , {t}_{w , j} + {y}_{j} ) + 1 - {P}_{s , i} ) N ( {x}_{j} ; 0 , {σ}_{w , i} ) N ( {y}_{j} ; 0 , {σ}_{s , i} ) d {x}_{j} d {y}_{j}$$
$$and$$
$${ℒ}_{i} ( wake ) = {\sum }_{j} \int \int ( ( 1 - 2 {P}_{w , i} ) {z}_{j} ( t ; {t}_{s , j} + {x}_{j} , {t}_{w , j} + {y}_{j} ) + {P}_{w , i} ) N ( {x}_{j} ; 0 , {σ}_{w , i} ) N ( {y}_{j} ; 0 , {σ}_{s , i} ) d {x}_{j} d {y}_{j}$$
wherein the one or more likelihood of sleep functions [symbol] ᵢ(sleep) and the one or more likelihood of wake functions [symbol] ᵢ(wake) represent a probability that the i^{th} one of the plurality of sleep status indication sources is properly reporting the individual's sleep state and wake state, respectively, after accounting for insertion errors, deletion errors, and timing errors.

25. A method according to claim 24:
wherein determining, with the computer, a multisource probabilistic sleep estimate for the individual by applying a data fusion algorithm to at least in part the received plurality of sleep functions further comprises at least in part:
determining both a likelihood of sleep function [symbol] ᵢ(sleep) and a likelihood of wake function [symbol] ᵢ(wake) for each i^{th} one of the plurality of sleep status indication sources, and
determining a multisource probabilistic sleep estimate P_{M}(sleep) or P_{M}(wake) according to at least one of the forms:
$${P}_{M} ( sleep ) = \frac{{\prod }_{i = 0}^{i = n} P ( {z}_{i} \text{\textbar} s = 1 ) P ( s = 1 )}{{\sum }_{k = 0}^{k = 1} {\prod }_{i = 0}^{i = n} P ( {z}_{i} \text{\textbar} s = k ) P ( s = k )} , \\ and$$
$${P}_{M} ( wake ) = \frac{{\prod }_{i = 0}^{i = n} P ( {z}_{i} \text{\textbar} s = 0 ) P ( s = 0 )}{{\sum }_{k = 0}^{k = 1} {\prod }_{i = 0}^{i = n} P ( {z}_{i} \text{\textbar} s = k ) P ( s = k )}$$
wherein P(zᵢ|s=1)= [symbol] ᵢ(sleep) and P(zᵢ|s=0)= [symbol] ᵢ(wake);
wherein P(s=0) and P(s=1) comprise constant parameters representing the probability of the individual being awake and asleep, respectively, at any given time;
wherein k represents an index variable for summing over all sleep states;
wherein n represents the number of sleep status indication sources within the plurality of sleep status indication sources; and
wherein P_{M}(sleep) and P_{M}(wake) represent the likelihood of sleep function and the likelihood of wake function, respectively, indicating the subject's corresponding probable wake state as indicated collectively by all of the plurality of sleep status indication sources after accounting for insertion errors, deletion errors, and timing errors.

26. A method, using a computer, for determining an estimated fatigue level for an individual based upon a multisource probabilistic sleep estimate, the method comprising:
receiving, at a computer, a plurality of sleep state functions for an individual within a time interval of interest, each sleep state function representing a likelihood of the individual being in a particular sleep-wake state at one or more times within the time interval of interest;
determining, with the computer, a multisource probabilistic sleep estimate for the individual by applying a data fusion algorithm to the received plurality of sleep state functions, wherein the data fusion algorithm comprises a combining operation operating on each of the sleep state functions; and
determining, with the computer, an estimated fatigue level for the individual by applying a mathematical fatigue model to the determined multisource probabilistic sleep estimate, the estimated fatigue level being indicative of a neurocognitive or neurobehavioral state of the individual, the mathematical fatigue model comprising a biomathematical model capable of determining a neurocognitive or neurobehavioral state of an individual based at least in part upon sleep data as input.

27. A computer program product embodied in a non-transitory medium and comprising computer-readable instructions that, when executed by a suitable computer, cause the computer to perform a method for determining a multisource probabilistic sleep estimate for an individual, the method comprising:
receiving, at a computer, a plurality of sleep state functions for an individual within a time interval of interest, each sleep state function representing a likelihood of the individual being in a particular sleep-wake state at one or more times within the time interval of interest; and
determining, with the computer, a multisource probabilistic sleep estimate for the individual by applying a data fusion algorithm to the received plurality of sleep state functions, wherein the data fusion algorithm comprises a combining operation operating on each of the sleep state functions.

28. A computer program product embodied in a non-transitory medium and comprising computer-readable instructions that, when executed by a suitable computer, cause the computer to perform a method for determining an estimated fatigue level for an individual based upon a multisource probabilistic sleep estimate, the method comprising:
receiving, at a computer, a plurality of sleep state functions for an individual within a time interval of interest, each sleep state function representing a likelihood of the individual being in a particular sleep-wake state at one or more times within the time interval of interest; and
determining, with the computer, a multisource probabilistic sleep estimate for the individual by applying a data fusion algorithm to the received plurality of sleep state functions, wherein the data fusion algorithm comprises a combining operation operating on each of the sleep state functions; and
determining, with the computer, an estimated fatigue level for the individual by applying a mathematical fatigue model to the determined multisource probabilistic sleep estimate, the estimated fatigue level being indicative of a neurocognitive or neurobehavioral state of the individual, the mathematical fatigue model comprising a biomathematical model capable of determining a neurocognitive or neurobehavioral state of an individual based at least in part upon sleep data as input.

29. A system for determining a multisource probabilistic sleep estimate for an individual, the system comprising:
a plurality of sleep status indication sources, the sleep status indication sources capable of reporting the sleep-wake status of on an individual over a time period of interest; and
a sleep data fusion module, the sleep data fusion module capable of determining a multisource probabilistic sleep estimate by applying a data fusion algorithm to the reported sleep-wake status of the individual as provided by the plurality of sleep status indication sources, the multisource probabilistic sleep estimate being representative of a probabilistic estimated sleep-wake status of the individual over the time interval of interest as indicated by the plurality of sleep status indication sources.

30. A system for determining an estimated fatigue level for an individual based upon a multisource probabilistic sleep estimate, the system comprising:
a plurality of sleep status indication sources, the sleep status indication sources capable of reporting the sleep-wake status of on an individual over a time period of interest;
a sleep data fusion module, the sleep data fusion module capable of determining a multisource probabilistic sleep estimate by applying a data fusion algorithm to the reported sleep-wake status of the individual as provided by the plurality of sleep status indication sources, the multisource probabilistic sleep estimate being representative of a probabilistic estimated sleep status of the individual over the time interval of interest as indicated by the plurality of sleep status indication sources; and
a biomathematical computation module, the biomathematical computation module capable of determining an estimated fatigue level of the individual by applying a biomathematical fatigue model to at least in part the determined multisource probabilistic sleep estimate, wherein the biomathematical fatigue model comprises a biomathematical model capable of determining a fatigue state of an individual based at least in part on sleep data.
